(19) United States
(12) Patent Application Publication
(10) Pub. No.: US 2002/0191916 A1
(43) Pub. Date: Dec. 19, 2002

(54) Vertical waveguide tapers for optical coupling between optical fibers and thin silicon waveguides

(75) Inventors: Michael B. Frish, Andover, MA (US); Philip B. Keating, Salem, MA (US); Eugene E. Fike, Amesbury, MA (US); Stuart A. Jacobson, Lexington, MA (US); Craig L. Keast, Groton, MA (US); Carl Bozler, Waltham, MA (US); Michael Fritze, Acton, MA (US); Jeffery M. Knecht, Brookline, NH (US); John J. Fijol, Shrewsbury, MA (US)

Correspondence Address: TESTA, HURWITZ & THIBEAULT, LLP, HIGH STREET TOWER, 125 HIGH STREET, BOSTON, MA, 02110, US

(73) Assignee: Confluent Photonics, Corporation, Andover, MA

(21) Appl. No.: 10/099,482

(22) Filed: Mar. 15, 2002

Related U.S. Application Data
(60) Provisional application No. 60/298,753, filed on Jun. 15, 2001.
(60) Provisional application No. 60/351,690, filed on Jan. 25, 2002.

(51) Int. Cl. G02B 6/26; G02B 6/30

(52) U.S. Cl. 385/43; 385/39; 385/49

(57) ABSTRACT

An apparatus for optical coupling between optical fibers and semiconductor waveguides and method of use thereof. The optical coupler comprises a tapered semiconductor structure having a cross section defined in a plane substantially perpendicular to a direction of propagation of light, which cross section has a dimension accurate to approximately 50 nanometer tolerance. The coupler has an optical index of refraction. The coupler has adjacent thereto material having an optical index less than that of the semiconductor, the adjacent material confining light within the semiconductor structure. In an exemplary embodiment, an optical communication device has two optical couplers disposed one at each end of a semiconductor waveguide to convey an optical communication from a source at one end to receiver at the other. In a further exemplary embodiment, a plurality of optical communication devices are disposed on a single semiconductor substrate.

### CROSS-REFERENCE TO RELATED APPLICATIONS

This application claims the benefit of U.S. provisional patent application serial No. 60/298,753, filed Jun. 15, 2001, and U.S. provisional patent application serial No. 60/351,690, filed Jan. 25, 2002, which applications are incorporated herein in their entirety by reference.

### FIELD OF THE INVENTION

This invention relates generally to systems and methods for coupling waveguides to optical fibers. More particularly, in one embodiment, the invention relates to coupling high index contrast waveguides to conventional optical fibers.

### BACKGROUND OF THE INVENTION

Integrated Optical Circuits (IOCs) have been under development in many laboratories and companies for over three decades. In an analogy to electronic integrated circuits, developers of IOCs envision the possibility of combining several or many optical processing functions on a single miniature platform, such as a semiconductor chip, fabricated using processes similar to those used for electronic chip production. These Planar Optical Chips (POCs) incorporate functional optical components such as linear or curved waveguides to conduct light from one location to another, filters fabricated from specially shaped waveguides that control the spectral characteristics of the light, and lenses and mirrors embedded in waveguides to alter the shape of the light. The POCs are interfaced to other optical components and devices via optical fibers.

The waveguide components in these IOCs generally comprise several layers of materials. In an exemplary two-dimensional planar or “slab” waveguide, a core layer of a material is sandwiched between two layers of clad material. The core material has a higher refractive index than the clad material. Similarly, in three-dimensional linear or curved waveguides, such as the common optical fiber, a core material is fully surrounded by a clad material.

Optical fibers are examples of low-index-contrast waveguides, wherein the core material is a type of doped silica (SiO₂, also referred to as “silicon dioxide”) having a refractive index generally no more than 1% greater than the undoped silica clad material. When utilized to transmit telecommunications optical signals, optical fibers are usually operating in single optical mode configuration, and typically have core diameters and mode sizes of about 9 μm (9000 nm). POCs intended for use in optical telecommunications networks are traditionally made of material systems similar to optical fibers. Because the optical modes at the input and output facets of these traditional POCs are well matched to the optical fiber mode, coupling of light between the optical fibers and the POC is simplified.

It is known, however, that low-index-contrast material systems are not optimum for IOCs. High-index-contrast material systems, such as a core layer of silicon having a refractive index of approximately 3.5 clad with silica having a refractive index of approximately 1.5, offer stronger light confinement in smaller dimensions. Silica used as an insulating layer on silicon is also referred to as “oxide” or “insulator.” The stronger light confinement enables miniaturization of functional optical components to sizes that are comparable to the wavelength of the confined light, and thereby enables dense integration of these optical devices on waveguide chips.

There are many practical uses of high-index-contrast waveguide chips, especially in telecommunications where there is currently an emphasis on developing means for routing and processing multiwavelength optical signals without converting them to other energy forms such as electricity. It is generally desirable to configure the waveguides for single mode propagation, to avoid the introduction of undesirable effects as a consequence of the differing propagation velocities of different modes. Waveguide core materials and waveguide optical modes having dimensions of approximately 250 nm or less are useful in maintaining single mode propagation.

The large mismatch between the common optical fiber dimension and the high-index-contrast waveguide dimension, and their respective mode sizes, complicates coupling of light from one to the other. A number of techniques have been utilized for optical coupling between these thin waveguides and conventional optical fibers, including prism couplers, grating couplers, tapered fibers and micro-lens mode transformers. None of these techniques offer the combination of high coupling efficiency, wavelength independence, reliability, manufacturability, ruggedness, and robustness demanded for use in low-cost high-volume telecommunications component production.

### SUMMARY OF THE INVENTION

In one aspect, the invention relates to devices, systems and methods for efficiently coupling light (including near-infrared wavelengths) between conventional low-index-contrast single mode optical fibers and high-index-contrast single mode (or low order multimode) waveguides on POCs.

In one aspect, the invention provides a novel device for coupling optical fibers to ultra-thin high-index-contrast waveguides by means of a coupler that is tapered in at least one dimension (i.e., vertically), and in some embodiments, additionally in a second dimension (i.e., laterally), fabricated as an integral extension of the thin waveguide.

In another aspect, the invention provides systems and methods that simplify the construction of high-index-contrast POCs. In some embodiments, waveguides are fabricated from very thin layers of silicon on oxide. State-of-the-art silicon fabrication techniques permit control of the waveguide shapes to tolerances of less than 50 nm, thereby enabling precise and reproducible manufacture of wavelength sensitive devices such as gratings and resonators.

In one aspect, this invention provides a platform for fabricating from Silicon-on-Insulator (SOI) wafers a number of optical structures useful for IOCs.

In one aspect, the invention features an optical coupler. The optical coupler comprises a silicon structure communicating light between a first cross-sectional area at a first end thereof and a second cross-sectional area at a second end thereof, the light having a propagation direction, the silicon structure having a cross-section defined upon a plane substantially perpendicular to said propagation direction, the cross section having a cross-sectional dimension accurate to within a +50 nanometer tolerance of a desired value, the silicon structure having adjacent thereto material having a refractive index less than the refractive index of silicon, the adjacent material confining light within the silicon structure. In one embodiment, the material adjacent the silicon structure comprises a substrate adjacent to the silicon structure and in a plane substantially parallel to said propagation direction.

In one embodiment, the optical coupler further comprises a layer of silicon upon which said substrate is disposed.

In one embodiment, said material adjacent the silicon structure comprises a selected one of silicon dioxide, silicon nitride, non-stoichiometric silicon nitride, silicon oxynitride, sapphire, and air. In one embodiment, a thickness of said material adjacent the silicon structure is greater than 500 nm.

In one embodiment, at least one of the first end and the second end is a facet. In one embodiment, the at least one facet comprises an optical coating applied to the surface thereof. In one embodiment, the at least one facet is shaped to communicate an optical beam with an adjacent single mode optical fiber with minimized insertion loss. In one embodiment, the at least one facet has an approximately square shape measuring approximately 11 μm×11 μm.

In one embodiment, a selected change of a dimension of one cross-section compared to the corresponding dimension of an adjacent cross-section is less than 2 percent of the distance between said adjacent cross-sections, the distance being measured along the propagation direction.

In one embodiment, a selected change of a dimension of one cross-section compared to the corresponding dimension of an adjacent cross-section, said dimension measured in a plane perpendicular to the plane of the substrate.

In one embodiment, said selected change of a dimension is less than 2 percent of the distance between said adjacent cross-sections, the distance being measured along the propagation direction.

In one embodiment, the invention relates to an optical coupler array comprising a plurality of optical couplers of claim 1, wherein said plurality of optical couplers are disposed upon a single silicon substrate.

In one embodiment, the invention features an optical communication device comprising the optical coupler of claim 1, wherein the first end is a facet. The invention also includes a waveguide disposed at least in part upon the same substrate as the optical coupler, an end of the waveguide abutting the second end of the optical coupler and having a substantially similar cross-section as that of the second end of the optical coupler.

In one embodiment, the waveguide comprises a strip having a substantially constant dimension perpendicular to the propagation direction of light. In one embodiment, the waveguide comprises a strip of silicon. In one embodiment, the waveguide propagates only one optical mode. In one embodiment, at least one cross-sectional dimension of the waveguide is less than 380 nm. In one embodiment, the optical waveguide is overcoated with a material having a refractive index less than that of the optical waveguide. In one embodiment, said overcoating material is a selected one of silicon dioxide, silicon nitride, non-stoichiometric silicon nitride, silicon oxynitride, and sapphire.

In one embodiment, the waveguide comprises at least one surface with a surface roughness less than 3 nanometers rms. In one embodiment, the optical communication device further comprises a second optical coupler disposed at a second end of the waveguide. In one embodiment, a selected one of the first optical coupler and the second optical coupler provides an input to the waveguide and the remaining optical coupler provides an output.

In one embodiment, the invention relates to an optical communication device array comprising a plurality of optical communication devices, wherein said plurality of optical communication devices are disposed upon a single silicon substrate. In one embodiment, a plurality of first optical couplers are disposed relative to each other with first selected positions and orientations, and a plurality of second optical couplers are disposed relative to each other with second selected positions and orientations.

In one embodiment, the invention relates to an optical communication device array comprising a plurality of optical communication devices, wherein said plurality of optical communication devices are disposed upon a single silicon substrate. In one embodiment, a plurality of first optical couplers are disposed relative to each other with first selected positions and orientations, and a plurality of second optical couplers are disposed relative to each other with second selected positions and orientations.

In one embodiment, the invention relates to an optical apparatus that communicates light. The optical communication device comprises an optical communication device array, the optical communication device array having an array of first ends and an array of second ends. The optical communication device includes at least one source of light to be communicated, the at least one source in optical communication with a selected first end of a first selected one of the plurality of optical couplers of the optical communication device array, at least one receiver of light, the at least one receiver in optical communication with the corresponding second end of the first selected one of the plurality of optical couplers of the optical communication device array, and at least one additional source or receiver of light in optical communication with an end of a second selected one of the plurality of optical couplers of the optical communication device, whereby a parameter or characteristic of the optical apparatus is improved by the inclusion of the optical coupler along a communication path between the source and the receiver as compared to the parameter or characteristic of the optical apparatus absent the coupler.

In one embodiment, the improved parameter or characteristic comprises at least a selected one of an efficacy of transferring optical power among the at least one transmitter and to the at least one receiver and the at least one additional source or receiver, the mechanical alignment of the at least one transmitter and the at least one receiver and the at least one additional source or receiver, and the crosstalk between at least two of the plurality of optical couplers.

In one embodiment, the invention relates to an optical apparatus that communicates light. The optical apparatus comprises an optical coupler, the optical coupler having a first end and a second end, a source of light to be communicated, the source in optical communication with the first end of the optical coupler, and a receiver of light, the receiver in optical communication with the second end of the optical coupler, whereby a parameter or characteristic of the optical apparatus is improved by the inclusion of the optical coupler along a communication path between the source and the receiver as compared to the parameter or characteristic of the optical apparatus absent the coupler.

In one embodiment, the improved parameter or characteristic comprises at least a selected one of an efficiency of transmission of optical power from the transmitter to the receiver, a polarization dependence of transmitted optical power, a dispersion of a transmitted light signal, and a shape of a transmitted light beam

In one embodiment, a shape of a transmitted light beam is measured at a location selected from one of a point adjacent a facetted end of the silicon structure and situated outside of the silicon structure, a point adjacent a facetted end of the silicon structure and situated within the silicon structure, a point situated inside the silicon structure adjacent a silicon waveguide, a point situated outside the silicon structure adjacent a silicon waveguide, and a point within a silicon waveguide.

In another aspect, the invention features an optical coupler. The optical coupler comprises a silicon structure communicating light between a first cross-sectional area at a first end thereof and a second cross-sectional area at a second end thereof, the light having a propagation direction, the silicon structure having a cross-section defined upon a plane substantially perpendicular to said propagation direction, the cross section having a cross-sectional dimension accurate to within a ±50 nanometer tolerance of a desired value. The optical coupler also includes an etch stop layer adjacent to the silicon structure and in the plane substantially parallel to said propagation direction, said etch stop layer comprising material that is substantially resistant to substances and processes that etch silicon and that is substantially transparent to the light propagating in the silicon structure. The optical coupler also comprises a first layer of silicon upon which said etch stop is disposed, a substrate upon which the first layer of silicon is disposed, said substrate comprising a layer of material having a refractive index less than the refractive index of silicon, and substantially confining light propagating in the first layer of silicon, and a second layer of silicon upon which said substrate is disposed.

In one embodiment, the etch stop layer comprises a material selected from the group consisting of silicon dioxide, silicon nitride, non-stoichiometric silicon nitride, silicon oxynitride, and sapphire. In one embodiment, the thickness of the etch stop layer is less than 300 nm.

In one embodiment, the invention relates to an optical communication device array comprising a plurality of optical communication devices, wherein said plurality of optical communication devices are disposed upon a single silicon substrate.

In one embodiment, a plurality of first optical couplers are disposed relative to each other with first selected positions and orientations, and a plurality of second optical couplers are disposed relative to each other with second selected positions and orientations.

In a further aspect, the invention relates to a method of optical communication. The method comprises the steps of providing an optical coupler, the optical coupler comprising a silicon structure communicating light between a facet at a first end thereof and an optical waveguide at a second end thereof, the light having a propagation direction, the silicon structure having a cross-section defined upon a plane substantially perpendicular to said propagation direction, the cross section having a cross-sectional dimension accurate to within a ±50 nanometer tolerance of a desired value, and communicating light along a communication path from a source in optical communication with the first end of the optical coupler to a receiver in optical communication with the second end of the optical coupler, whereby a parameter or characteristic of the communication of light from the source to the receiver is improved by the inclusion of the optical coupler along the communication path between the source and the receiver as compared to the parameter or characteristic of the communication absent the coupler.

In one embodiment, the improved parameter or characteristic comprises at least a selected one of an efficiency of transmission of optical power, a polarization dependence of transmitted optical power, a dispersion of a transmitted light signal, and a shape of a transmitted light beam. In one embodiment, a shape of a transmitted light beam is measured at a location selected from one of a point adjacent a facetted end of the silicon structure and situated outside of the silicon structure, a point adjacent a facetted end of the silicon structure and situated within the silicon structure, a point situated inside the silicon structure adjacent a silicon waveguide, a point situated outside the silicon structure adjacent a silicon waveguide, and a point within a silicon waveguide.

In still a further aspect, the invention relates to an optical coupler that communicates light between a facet and an optical waveguide. The optical coupler comprises a semiconductor structure communicating light between a facet at a first end thereof and an optical waveguide at a second end thereof, the light having a propagation direction, the semiconductor structure having a cross-section defined upon a plane substantially perpendicular to said propagation direction, the cross section having a cross-sectional dimension accurate to within a ±50 nanometer tolerance of a desired value.

In one embodiment, a first cross-section has the shape of the facet and a second cross-section has the shape of the optical waveguide. In one embodiment, a change of a dimension of one cross-section compared to a corresponding dimension of an adjacent cross-section is less than 2% compared to a distance between said adjacent cross-sections, the distance being measured along the propagation direction. In one embodiment, the optical communication device comprises the optical couple, and further comprises a substrate adjacent said optical coupler.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is a diagram that shows an illustrative embodiment of an optical fiber coupling device, not shown to scale, according to principles of the invention;

FIG. 1B is a diagram that shows a section through another illustrative embodiment of an optical fiber coupling device, not shown to scale, according to principles of the invention;

FIGS. 2A, 2B and 2C are diagrams that present the results of a calculation of optical power propagation through an illustrative optical fiber coupling device, in which optical power is input from the bottom in the illustrated structure;

FIGS. 3A, 3B and 3C show an exemplary gray scale mask utilized in a process for fabricating a device for coupling an optical fiber to an SOI waveguide, according to principles of the invention;

FIGS. 4A and 4B are Scanning Electron Micrographs of an illustrative SOI cantilever embodiment useful as a mold to fabricate a device for coupling an optical fiber to an SOI waveguide, according to principles of the invention;

FIGS. 4C and 4D are Scanning Electron Micrographs of an illustrative SOI bridge embodiment useful as a mold to fabricate a device for coupling an optical fiber to an SOI waveguide, according to principles of the invention;

FIG. 5A is a diagram that shows a top view of a first illustrative embodiment of an optical component that provides a fiber to SOI transition, according to principles of the invention;

FIG. 5B is a diagram that shows a section through the thickness of the optical component shown in FIG. 5A, according to principles of the invention;

FIG. 6A is a diagram that shows a top view of a second illustrative embodiment of an optical component that provides a fiber to SOI transition, according to principles of the invention;

FIG. 6B is a diagram that shows a section through the thickness of the optical component shown in FIG. 6A, according to principles of the invention;

FIGS. 7A and 7B are diagrams that show cross-sections of examples of illustrative transition structures used to minimize reflection of the light from the refraction interface between the waveguide and the optical fiber, according to principles of the invention;

FIGS. 7C, 7D and 7E are diagrams that show an illustrative example of the fabrication process used to manufacture a transition structure such as that shown in FIG. 6B, according to principles of the invention;

FIGS. 8A and 8B are diagrams that show a third illustrative embodiment comprising a diffraction grating, in top view and in cross-section, respectively, according to principles of the invention;

FIGS. 9A and 9B are diagrams that show a fourth illustrative embodiment comprising an etalon, in top view and in cross-section, respectively, according to principles of the invention;

FIGS. 10A and 10B are diagrams that show an illustrative embodiment of a micro electro mechanical optical switch, in top view and in cross-section, respectively, according to principles of the invention;

FIG. 11 is a diagram that shows three illustrative taper designs for optical couplers of the invention;

FIG. 12 is a diagram, not to scale, showing the cross sections of the three optical couplers of FIG. 11 and their associated waveguides at selected positions along the optical propagation direction;

FIG. 13 is a graph that shows an illustrative theoretical analysis of the coupling between an optical fiber and an optical coupler of the invention;

FIG. 14 is a diagram that shows the variation of power in an optical coupler of he invention as a function of the length of the taper;

FIG. 15 is a diagram that depicts the propagation of optical power within a coupler of the invention as a function of angle of impingement of the illumination;

FIG. 16 is a microimage of several illustrative optical couplers of the invention;

FIG. 17 is a schematic diagram that shows the mode shape of an optical beam comprising a Gaussian TE mode as it traverses an optical coupler of the invention;

FIG. 18 is a schematic diagram of an illustrative application using the optical coupler of the invention;

FIG. 19 is a schematic diagram showing features of the structure of the waveguide of the communication device of the invention;

FIG. 20 is a diagram that shows illustrative calculations of polarization mode dispersion in silicon waveguides used with optical couplers of the invention; and

FIG. 21 is a diagram that shows illustrative calculations of power loss as a function of sidewall roughness.

### DETAILED DESCRIPTION

Optical Coupling Device

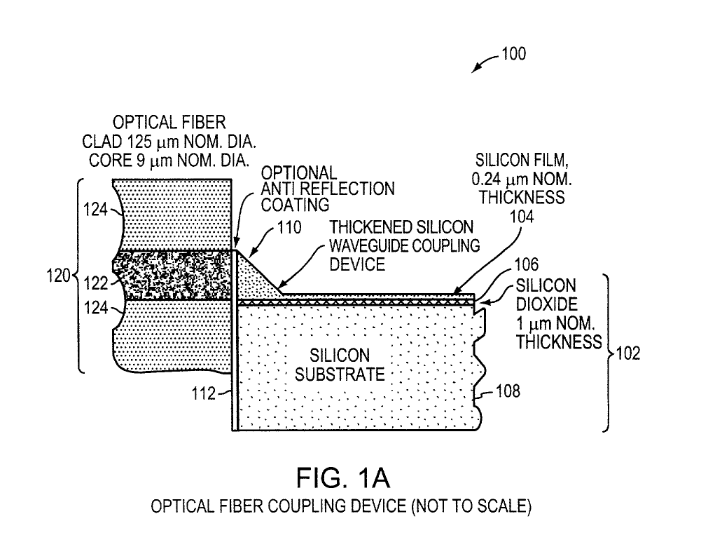

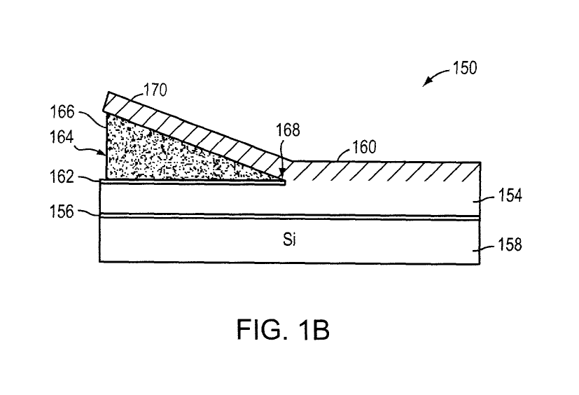

FIG. 1A is a diagram 100 that illustrates an exemplary embodiment of the coupling device fabricated, as an example, on a silicon-based wafer 102. In one embodiment, a Silicon-on-Insulator (SOI) wafer 102 is utilized as the platform upon which the waveguide structures are fabricated. An SOI wafer 102 is one that has been fabricated with a thin (approximately 240 nm, or 0.24 μm) layer of high-refractive index single crystal silicon (Si) 104 overlaying a layer of relatively-low refractive index silicon dioxide (SiO₂) 106, which in turn has been grown or deposited on a silicon single crystal wafer substrate 108. In electronic applications, the oxide layer serves as an electrical insulator, hence the term silicon-on-insulator. Fabrication of SOI wafers is a highly developed commercial process wherein the silicon-on-insulator film can be made uniform in thickness to within 40 Å and the insulating layer can be made arbitrarily thick. When used as an optical waveguide, the thin Si layer 104 serves as the core guiding layer. Its uniformity enables optical propagation with losses of less than 0.1 db/cm. By using advanced lithography, patterns having dimensions as small as 0.02 μm are created in the silicon layer, and equally small optical structures may be fabricated simply by etching into and through the silicon. In some circumstances another layer of SiO₂ (not shown) may be deposited or formed upon the silicon guiding layer 104. If the structure includes a top layer of SiO₂, the structure has a total of four layers.

Referring still to FIG. 1A, according to principles of the invention, the end of the waveguide 110 where light enters or exits the silicon layer 104 is thickened. Thickening may be accomplished, for example, by depositing, growing, or attaching additional silicon upon the silicon layer 104. The thickened region may include thin barrier layers (not shown) of oxide or other materials that are essentially transparent to transmitted light but are included to simplify fabrication and shaping processes. In the embodiment shown in FIG. 1A, the thickened silicon section 110 is depicted as having a planar facet at one end 111. In other embodiments, the end 111 of the thickened segment may be shaped, for example with curved surfaces in place of the planar facets, or coated, for example with anti-reflective materials, to optimize power transfer to or from optical fibers. The end 111 of the thickened section can be an input or an output. Optionally, the end 111 of the thickened silicon waveguide 110 can include one or more layers of anti-reflection coating material 112 to optimize power transfer to or from other components. In FIG. 1A, an optical fiber 120, having a core 122 and having an annular cladding material 124 outside the core 122, is shown as a component from which power is transferred.

The height of the thickened silicon section 110 varies from that of the silicon guiding layer 104, nominally 0.24 μm, to a dimension slightly larger than that of the optical fiber core 122 to which the waveguide couples optically, nominally 10 μm, providing a mode field dimension change on the order of 50:1. In one embodiment the thickened silicon 110 is in the shape of a taper where the rate of change of waveguide height along its length is optimized to minimize loss of optical power by mode conversion and radiation. The width of the waveguide taper may also be controlled to optimize transmitted power.

FIG. 1B is a diagram 150 that shows a section through another illustrative embodiment of an optical coupler comprising a taper fabricated on a semiconductor substrate, such as a silicon substrate 158. The substrate 158 is preferably single crystalline material having a selected crystallographic orientation, with a selected crystallographic direction oriented at a desired angle to a surface normal of the substrate 158. A layer 156 of material is disposed adjacent the substrate 158. The layer 156 comprises a material having a refractive index less than a semiconductor that is used as an optical waveguide 154. The optical waveguide 154 is disposed adjacent the layer 156. A second layer 160 of material having a refractive index lower than the material of the optical waveguide 154 is disposed adjacent the optical waveguide 154.

In a preferred embodiment, the substrate 158 is silicon, the layer 156 is silicon dioxide, the semiconductor optical waveguide 154 is silicon, and the second layer 160 is silicon dioxide. In some embodiments, the thickness of one or both of layers 156 and 160 is at least 500 nanometers (nm). In other embodiments, the substrate 158 is another elemental semiconductor, a semiconductor such as silicon-germanium alloy, a compound semiconductor such as InP or GaAs or a ternary or higher order alloy of such compound semiconductors. In some embodiments, the optical waveguide 154 is another elemental semiconductor, a semiconductor such as silicongermanium alloy, a compound semiconductor such as InP or GaAs or a ternary or higher order alloy of such compound semiconductors. In some embodiments, the layer 156 and the layer 160 comprise a selected one of silicon dioxide, silicon nitride, non-stoichiometric silicon nitride, silicon oxynitride, sapphire, and air. The layer 156 and the layer 160 can comprise the same material or the layer 156 can comprise different material than the layer 160. Additional layers, not shown in FIG. 1B because they lie outside the plane of the section shown, of material having an optical index less than that of the semiconductor are present to completely surround the layer of semiconductor material 154. The layers 156 and 160, along with the additional layers not shown, provide a structure that causes light that propagates within the semiconductor layer 154 to be confined within the semiconductor layer 154.

The optical coupler comprises a semiconductor structure 164 communicating light between a first cross-sectional area at a first end 166 thereof and a second cross-sectional area at a second end 168 thereof. The semiconductor structure 164 is preferably made from silicon, but can be made from other semiconductor materials, such as those enumerated above. The light has a propagation direction in the semiconductor structure 164. The semiconductor structure 164 has a cross-section defined upon a plane substantially perpendicular to the propagation direction of the light. In one embodiment, in which the semiconductor structure 164 comprises silicon, the cross section has a cross-sectional dimension accurate to within a ±50 nanometer tolerance of a desired value. It has been found that maintaining the silicon structure within such tolerance improves the parameters of performance and/or characteristics of the optical coupler, as will be described in greater detail below. A layer 170 of material having an optical index less than that of the semiconductor structure 164 is disposed adjacent the semiconductor structure 164, so as to confine light within the semiconductor structure 164.

In some embodiments, the semiconductor structure 164 has a tapered shape that is defined by a change of a dimension of one cross-section compared to the corresponding dimension of an adjacent cross-section. In a preferred embodiment, the change of a dimension is less than 2 percent of the distance between adjacent cross-sections, the distance being measured along the propagation direction of light within the semiconductor structure 164.

As shown in FIG. 1B, in some embodiments, a layer 162 of material is provided between layer 154 and structure 164, the layer 162 being sufficiently thin so as to be substantially transparent or optically innocuous with regard to the light that propagates through structure 164 and travels within layer 154. The layer 162 comprises material that is resistant to chemicals that etch the material from which semiconductor structure 164 is made. In a preferred embodiment, the semiconductor structure 164 is silicon, and the layers 162 and 170 are silicon dioxide. The layer 162 is an etch stop layer having a thickness sufficient to avoid pinholes or other defects that would permit etching of an underlying layer. The minimum thickness required for etch stop layer 162 to be effective will in general depend on the method by which layer 162 is created. Other attributes of the semiconductor structure 164 will be described in greater detail below.

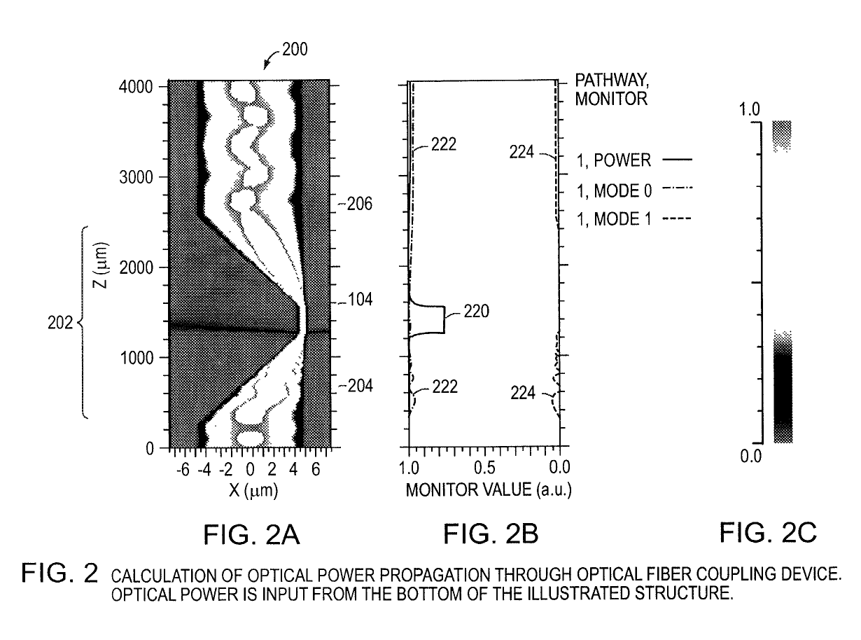

FIG. 2A is a diagram 200 that illustrates a calculation of the optical power propagating through a composite two-dimensional waveguide structure 202 featuring a tapered input section 204 and a tapered output section 206. The refractive indices of the materials comprising this structure are selected to simulate Si as the core material, with oxide as the clad material on both sides of the Si. The tapered input section 204 (corresponding to the thickened silicon waveguide 110 of FIG. 1A) receives light from a computed mode field similar to that created by a conventional optical fiber 120. The light propagates through the tapered input section 204 into a thin Si layer 104 capable of supporting only a single mode. The light transits the thin Si section 104 and exits through the output section 206. In FIG. 2A, the optical power distribution within the composite waveguide is illustrated by color coding. FIG. 2C shows the color code in units of relative power.

In FIG. 2B, line 220 shows the power contained in the Si core 104 of the waveguide at each position (denoted by the dimension Z in units of μm) along its length but integrated in the x-direction across the width. Also shown in FIG. 2B is the power in each of the first two propagation modes. Mode 0 is illustrated by line 222, and mode 1 by line 224. These curves show that approximately 97% of the power entering the waveguide also exits the waveguide. In the thin single-mode region, only about 70% of the power (see line 220) is contained within the Si core 104, and the remaining power is guided evanescently within the oxide clad material. In the tapered input region 204, some transfer of power back and forth between Mode 0 and Mode 1 occurs, but more than 98% of the output power remains in Mode 0 (see line 222) as is desired for efficient coupling to an output optical fiber.

Apparatus built according to principles of the invention differs from conventional adiabatic tapers and from prism couplers in that the thickened silicon section 110 is directly attached to the waveguide 104, is formed substantially of the same material as the guiding layer, and provides for a continuous change in height in the direction of light propagation. Those skilled in the art of optical waveguide design and fabrication have in the past generally precluded consideration of these so-called vertical tapers. Procedures for fabricating vertical tapers upon silicon or other substrates of semiconductor materials by conventional deposition, lithographic, and etching processes were considered to be impractical for reliable fabrication in high-volumes. Processes for accomplishing the waveguide thickening are therefore a novel feature of the invention.

Two alternative fabrication processes have been developed, employing for example epitaxial or polycrystalline silicon growth. The fabrication processes are referred to herein as the gray-scale mask technique and the mold technique.

Fabrication Processes

Gray-scale mask

In the gray-scale mask technique, vertically tapered waveguides are created by a modification of standard semiconductor fabrication techniques. The general steps of standard semiconductor processing techniques, as is known in the art, include depositing a uniform layer of a photoresist material on a silicon wafer, then irradiating the photoresist with a pattern of light, and subsequently developing the photoresist by a chemical process that removes either the irradiated or the non-irradiated photoresist to expose bare silicon in the desired pattern. Thereafter, the exposed silicon is removed to a predetermined depth by an etching process. In a later step, the remaining photoresist is removed with yet another process. During the etching of the silicon, some of the remaining photoresist is also etched. Typically, the thickness of the photoresist is chosen to preclude etching of silicon in areas beneath photoresist that is not removed when developed.

In conventional photolithography, the light utilized in the patterning step is created in a photolithography tool. The illumination pattern is created by a mask placed in the path between the photolithography light source and the silicon wafer. In the standard optical lithography process, the mask is a glass plate with patterned areas blocked by an opaque material such as chrome. The transparent, or unblocked, areas transmit light to the silicon while the blocked areas prevent light transmission. During the duration of the exposure in the standard optical lithography process, light projected through the mask onto the photoresist is either substantially “on” in unblocked areas or substantially “off” in blocked areas. The subsequent photoresist developing process ideally either fully removes the photoresist or removes substantially none at all. Thus, conventional lithography can be thought of as a “binary” process requiring the use of a high contrast resist for optimum performance. The subsequent silicon etch step removes exposed silicon at a first rate, generally fixed or substantially constant in time, and described in terms of depth of etch per unit of time, while removing remaining photoresist at a different, usually much slower, rate. The ratio of the two rates is called the etch ratio.

In contrast to the conventional photolithographic method, the gray-scale technique, which is also a known technique, utilizes a mask which is designed to project onto the photoresist a photolithography light beam of variable intensity as a function of position. This is achieved by pixellation of the desired pattern with a pitch chosen such that the pixel structure is not resolved by the lithography projection system. Thus the image is a simple two-dimensional intensity pattern containing only zeroth order diffraction components. Furthermore, the resist is designed so that its depth of removal during the developing step is dependent upon the exposure it receives. Typically, a low contrast resist provides optimum performance, in contradistinction to the high contrast resist used in conventional photolithography. As a result, when the photoresist irradiated through the gray-scale mask is developed, the resulting photoresist pattern is in general not either substantially “on” or substantially “off.” Instead, the photoresist is patterned so that the thickness at each point is determined by the local exposure, resulting in a photoresist layer having varying thickness determined at least in part by the intensity of illumination that reached the photoresist at specific locations. Thus, gray scale lithography can be thought of as an “analog” process, rather than as a “binary” process, in that it provides a range of photoresist thicknesses, rather than merely the presence or absence of photoresist at some location.

When the photoresist layer is subjected to the subsequent silicon etch step, the photoresist is etched as well, although at a different rate. The thinner regions of photoresist are fully removed in a shorter time interval that the thicker regions of photoresist, and thereby expose underlying silicon at an earlier time than the silicon is exposed under thicker regions of photoresist. The depth to which the underlying silicon is etched is therefore determined by the thickness of the photoresist after being developed, the etch ratio, and the etch time. The result is that the depth of the silicon etch can be made to vary across the silicon surface in a predetermined fashion. In this way, three dimensional relief patterns can be transferred from the resist to the underlying silicon layer.

The following steps are utilized in conjunction with the gray-scale mask technique to create on SOI wafers arrays of waveguides having vertical taper input and output structures according to the principles of the invention:

1) A Silicon-on-Insulator (SOI) wafer is selected. In some embodiments, this wafer can have been previously processed to include etched structures as well as deposited films to create, for example, the thin waveguides that transmit light to and from the vertical tapers.

2) A thin layer of oxide is deposited on the silicon.

3) The wafer is coated with photoresist, patterned with openings in the regions desired for the vertical tapers, and developed in the conventional manner.

4) The portions of thin oxide layer exposed by the openings in the photoresist mask are removed by etching, thereby exposing the thin silicon layer below the openings.

5) The remaining photoresist is stripped away.

6) A combination of selective and non-selective epitaxial silicon is grown on top of the wafer, providing high quality epitaxial silicon in the regions of the exposed silicon, and poly-silicon growth in regions far from the exposed silicon. This epitaxial layer is grown to the desired maximum height of the vertical taper, which is nominally 11 microns in some embodiments.

7) Optionally, depending on the flatness of the epitaxial layer, polishing of the top of the layer can be performed.

8) Photoresist is spun on top of the epitaxial silicon and patterned by irradiation through the gray scale mask.

9) The photoresist is developed and the wafer is subjected to a silicon etch, transferring the gray scale pattern into the epitaxial silicon as described above. The thin oxide layer on top of the thin silicon in areas not subjected to the removal step 4 above serves as an etch stop preventing removal of silicon below it.

10) Optionally, a smoothing process (such as thermal oxidation followed by a strip) can be performed on the vertical taper structure.

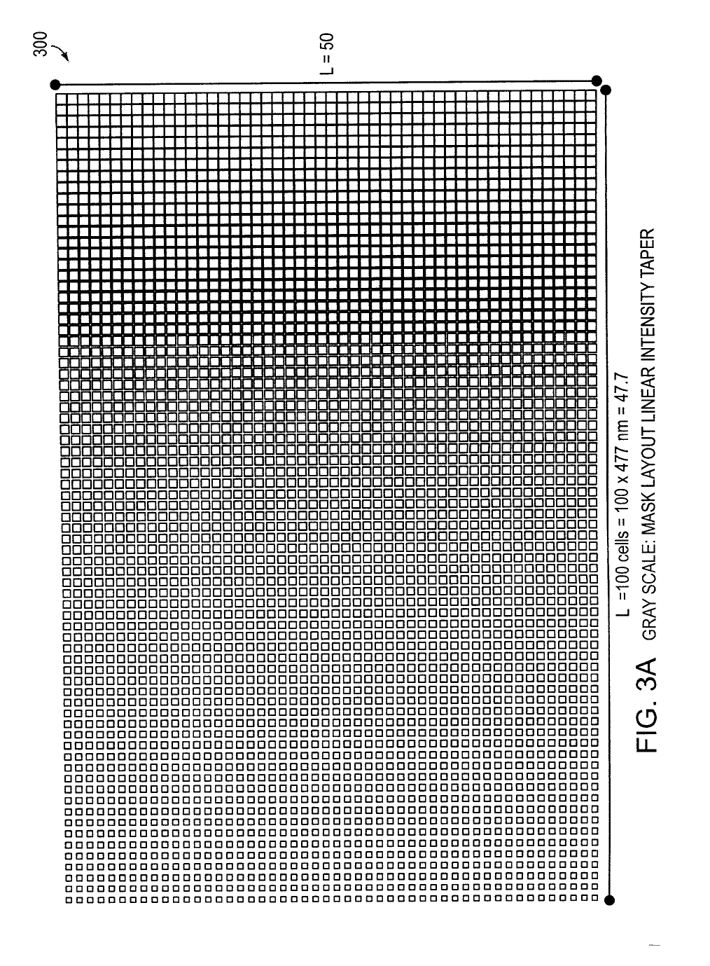

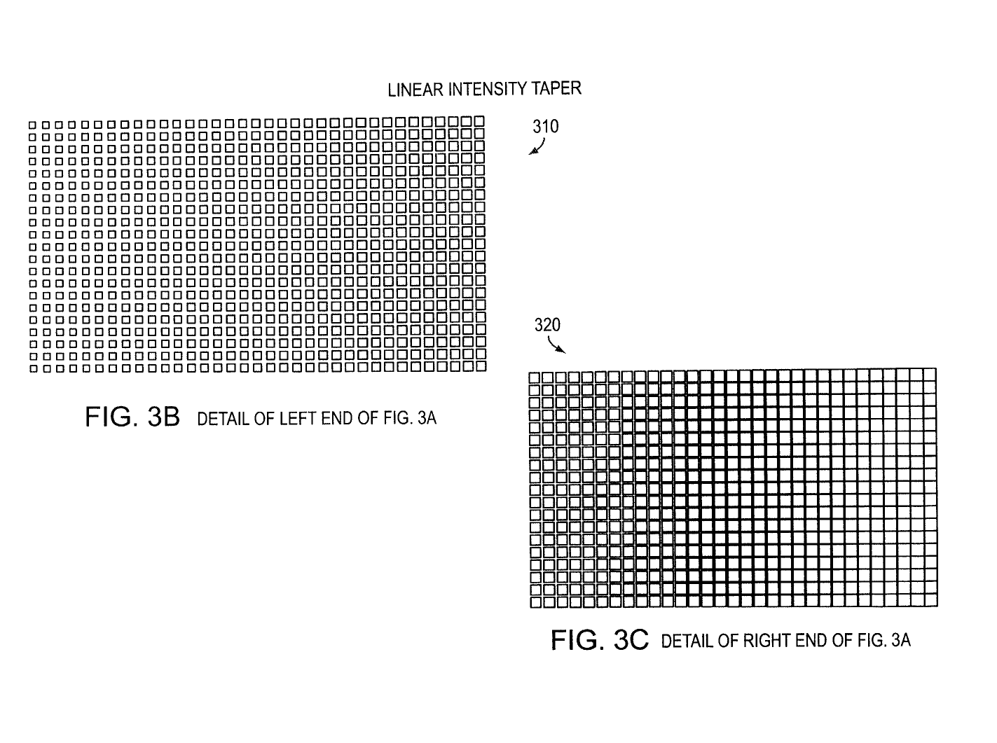

FIGS. 3A, 3B and 3C are drawings of an exemplary gray scale lithography mask utilized for fabrication of the vertical taper structure. FIG. 3A shows the entire mask, 300, design to provide a linear change in open area, and thus exposure, from left to right. There is no variation from top to bottom. FIG. 3B shows a detailed view of a section of the left side, 310, of the mask while FIG. 3C shows a detailed view of the right side, 320.

The Mold Technique

In the mold technique, a mold in the shape of the outer surface of the vertical taper is formed at the input or output end of the thin silicon waveguide. The mold is initially hollow and is subsequently backfilled with epitaxial silicon by a low-pressure chemical vapor deposition process. Finally, the mold is removed leaving only the added silicon in substantially the shape of the mold.

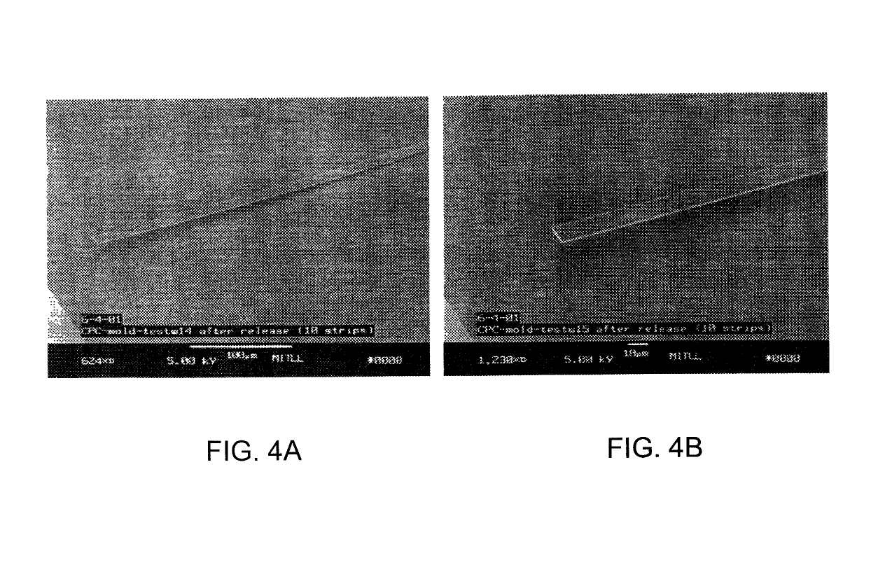

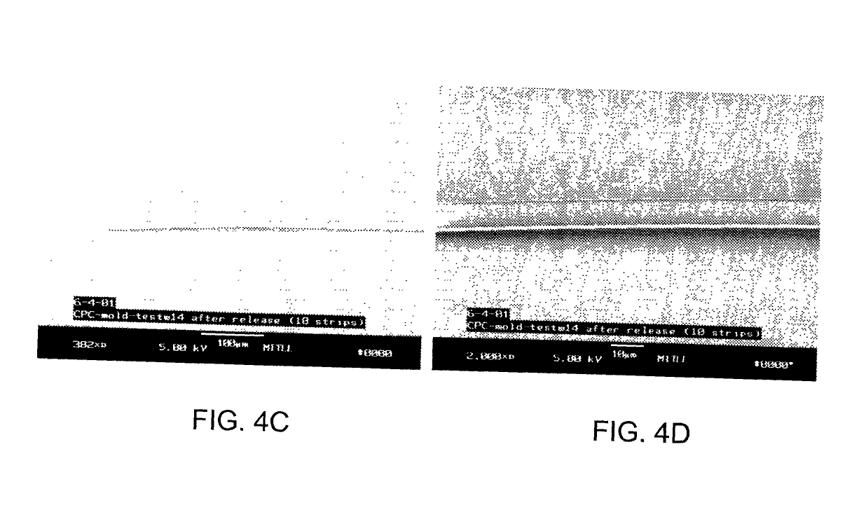

FIGS. 4A and 4B are Scanning Electron Micrographs of an illustrative SOI cantilever embodiment useful as a mold to fabricate a device for coupling an optical fiber to an SOI waveguide. FIGS. 4C and 4D are Scanning Electron Micrographs of an illustrative SOI bridge embodiment useful as a mold to fabricate a device for coupling an optical fiber to an SOI waveguide.

The mold technique comprises the following steps:

1) An SOI wafer is selected. In some embodiments, this wafer can have been previously processed to include etched structures as well as deposited films to create, for example, the thin waveguides that transmit light to and from the vertical tapers.

2) The wafer is coated with a thin layer of photoresist, patterned by irradiation through an appropriate mask, and developed to leave islands of photoresist having the lateral shape of the desired vertical taper structure. In some embodiments, the photoresist has the shape of a cantilever that will be released later in the process.

3) The islands of photoresist are carbonized, as is known in the semiconductor processing arts.

4) A stressed oxide layer is deposited. This layer may be a combination of films having compressive and tensile stresses. The stress is designed so as to provide sufficient force to bend the cantilever when it is released, causing one end to rise above the substrate. See FIGS. 4A and 4B. Alternatively, the stress is designed to be compressive so as to provide sufficient upward bow in a bridge held to the substrate at both ends after the release step. See FIGS. 4C and 4D.

5) Photoresist is again spun on the wafer, patterned with windows surrounding three sides of the desired cantilever, and developed to expose the underlying SiO₂. In the bridge alternative, a suitable pattern is formed in the photoresist, and is developed to expose the underlying SiO₂ to permit the bridge structure to attach to the silicon at both ends.

6) The exposed SiO₂ is etched down to the underlying carbonized resist and silicon. This step forms an oxide cantilever that is bonded to the SOI wafer by the carbonized resist at one end, and to the silicon at one location, or a bridge that is bonded to the silicon at both ends.

7) The carbonized resist is removed using a dry process such as an oxygen plasma etch, thereby freeing one end of the cantilever. One end of the cantilever remains attached to the SOI. In the case of the bridge alternative, both end of the bridge remain attached to the SOI. Upon completion of this step, a gap opens between the cantilever or the bridging member and the underlying silicon layer, thereby exposing the silicon. The mechanical stresses created in the SiO₂ layers during their deposition causes the cantilever or the bridge member to deflect out of the plane of the wafer, with the free end or section rising to the level of the desired height of the vertical taper wedge, which is nominally 11 μm in some embodiments. The hollow volume beneath the deflected SiO₂ cantilever and above the newly exposed silicon layer represents the vertical taper mold. A raised cantilever mold fabricated by this process is shown in FIGS. 4A and 4B, which include two photomicrographs obtained by Scanning Electron Microscopy.

8) Selective epitaxial silicon is deposited to fill the mold volume from the silicon layer to the Sio₂ cantilever or to the bridge member.

9) Typically, the epitaxial silicon overfills the lateral extents of the cantilever mold or bridging member mold volume. This overgrowth is removed by a vertical silicon etch, using the SiO₂ cantilever or the bridging member as a mask to protect the desired vertical taper shape. This process leaves a vertically tapered epitaxial silicon structure having predetermined dimensions directly on top of the original thin silicon layer.

10) If desired, the SiO₂ mold shell layer (i.e., the cantilever or the bridge) can be removed.

11) Optionally, a smoothing process (such as thermal oxidation followed by a strip) can be performed on the vertical taper structure.

12) Optionally, in the case of the bridge alternative, some of the selective epitaxial silicon can be removed to leave a taper having predetermined physical characteristics, for example by polishing off a portion of the material.

13) Alternatively, the bridge structure and its underlying SOI wafer can be separated for example by cleaving, sawing, or directionally etching, in one embodiment at the midpoint of the bridge, thereby producing two tapered structures on two portions of substrate in a single operation.

Optical couplers fabricated according to the principles of the invention, and devices and systems that comprise such optical couplers, can be advantageously manufactured. Such couplers, devices and systems provide improved performance, and can be manufactured at reduced manufacturing cost, and in shorter time periods, as compared to similar optical devices or systems that do not comprise optical couplers that employ the principles of the invention.

Other SOI Structures

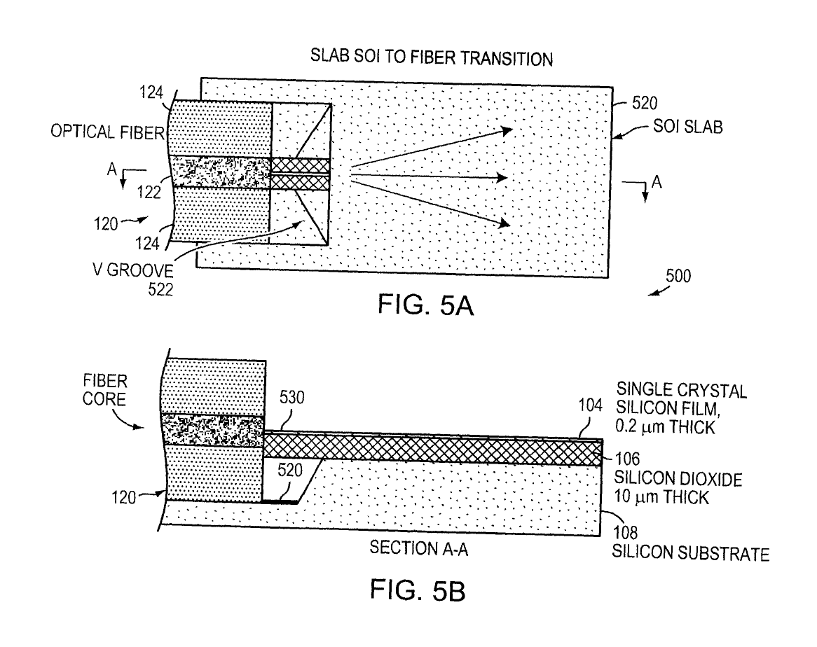

FIG. 5A is a diagram 500 that shows a top view of a first illustrative embodiment of an optical component for coupling a conventional optical fiber to an waveguide. The optical fiber 120 is clamped or welded in place in an anisotropically etched V groove 522 at the edge of a silicon substrate 520. FIG. 5B is a diagram that shows a section through the thickness of the illustrative embodiment shown in FIG. 5A. The optical fiber 120 is butted against the SOI layer 104 where the substrate has been etched away from under the insulating layer 106, so that a waveguide strip 530 connected to the rest of the slab is cantilevered over the silicon substrate 520. The strip 530 is long enough so that the light passing through the silicon dioxide will transfer into the silicon on top. There are many subtleties to be optimized in this component. For example, the light wave coming out of the fiber is usually single mode. It is desirable for many applications to maintain a single mode. As the light wave transfers from the fiber to the SOI higher order modes are likely to be generated. It may be necessary to provide silicon dioxide on both the top and bottom of the SOI layer, and it may be necessary to provide a long taper in the thickness of the SOI to reduce it to zero thickness at the junction with the fiber.

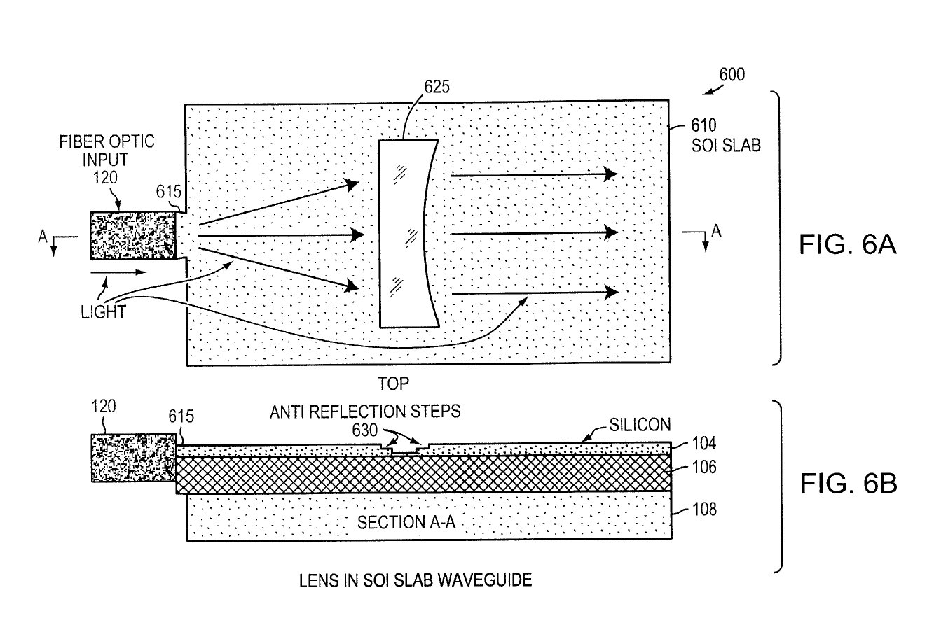

FIG. 6A is a diagram 600 that shows a top view of a second illustrative embodiment of an optical component for coupling a conventional optical fiber to an SOI waveguide. This embodiment comprises a lens 625. The light enters the SOI slab 610 from an optical fiber 120 via the fiberoptic connection 615, shown here in an abbreviated form, then is spread outward by a diffractive element, not shown. The light then enters the lens 625. The lens 625 comprises a region of thinner silicon.

FIG. 6B is a diagram that shows a section through the thickness of the optical component shown in FIG. 6A. The thinner silicon has a smaller effective refractive index causing the light passing across the steps to refract. To make the lens efficient, steps 630 are used to minimize reflection of the light from the refraction interface.

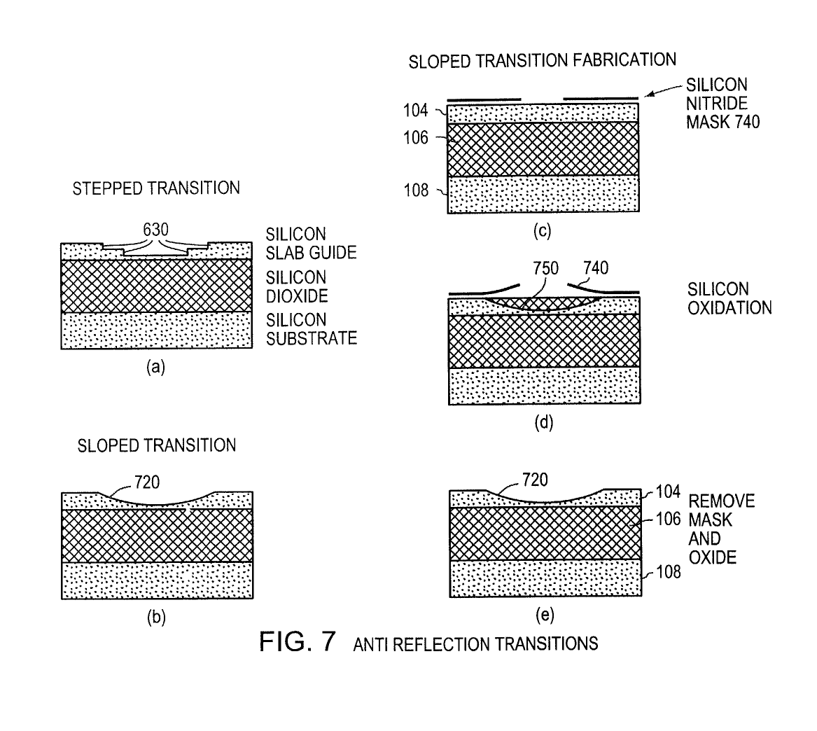

The steps 630 are shown in more detail in FIG. 7A. FIGS. 7A and 7B are diagrams that show cross-sections of examples of illustrative transition structures used to minimize reflection of the light from the refraction interface between the waveguide and the optical fiber. FIG. 7B shows a sloped wall 720 that is used as an alternative to the structure of FIG. 7A.

FIGS. 7C, 7D and 7E are diagrams that show an illustrative example of the fabrication process used to manufacture a transition structure such as that shown in FIG. 7B. FIG. 7C shows a wafer which includes a silicon nitride mask 740, formed on the silicon layer 104 by reaction with a nitrogen bearing gas such as ammonia (NH₃), or by deposition of Si₃N₄ for example by chemical vapor deposition (CVD). The nitride can be deposited over a thin oxide grown on the silicon 104 waveguide layer. The silicon exposed by the gap in the nitride layer is oxidized. The oxide 750 grows radially beneath the nitride as shown in FIG. 7D. By varying the thickness of the nitride film 740 and its underlying stress release oxide not shown, the radial growth and thus the slope of the oxide interface can be controlled over a range of different values. Finally the nitride mask and oxide are removed, leaving the silicon structure 720 shown in FIG. 7E.

With an appropriately designed lens, a parallel beam emerges from the lens. Because the SOI slab wave-guide is asymmetrical, the guide cuts off if the silicon is very thin. In some embodiments, the silicon dioxide is removed from under the lens region to avoid losing the light in the guide.

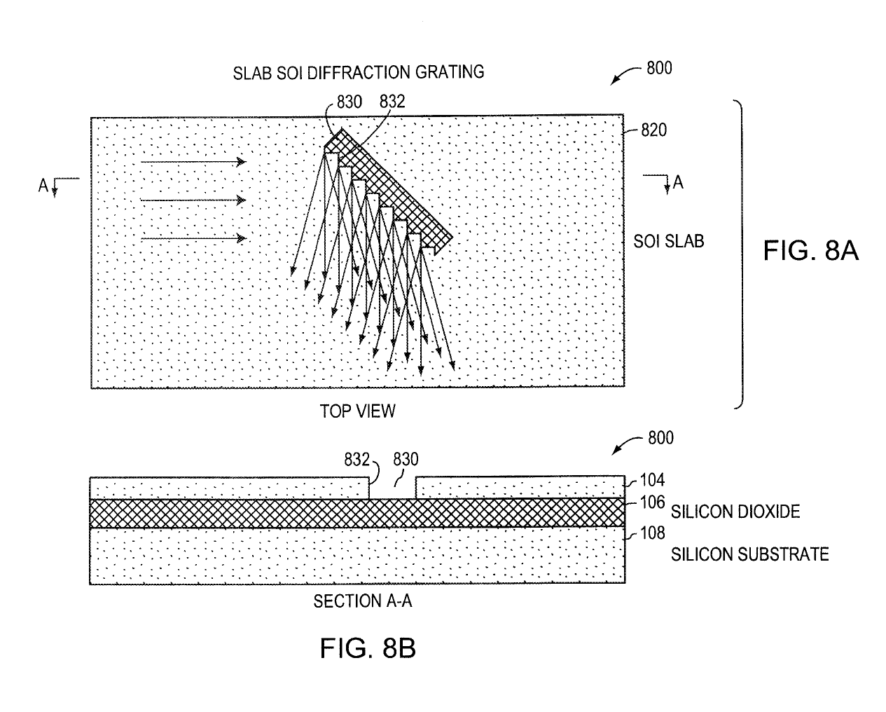

FIGS. 8A and 8B are diagrams 800, in top view and in cross-section, respectively, that show an illustrative embodiment of a diffraction grating 830 etched into the SOI slab waveguide 820. The grating is fabricated by silicon lithography and etching processes. A mask is fabricated describing the grating. The SOI wafer is coated with photoresist, exposed with the grating mask in place, developed, and etched. The process removes the silicon film in the form of the grating. Thus, the grating teeth form the edges of the slab waveguide. Light propagating through the waveguide that strikes the grating is dispersed into its multiple wavelengths upon reflection from the grating. The exposed surface 832 of the grating may be coated with a reflective material such as aluminum to enhance the grating efficiency.

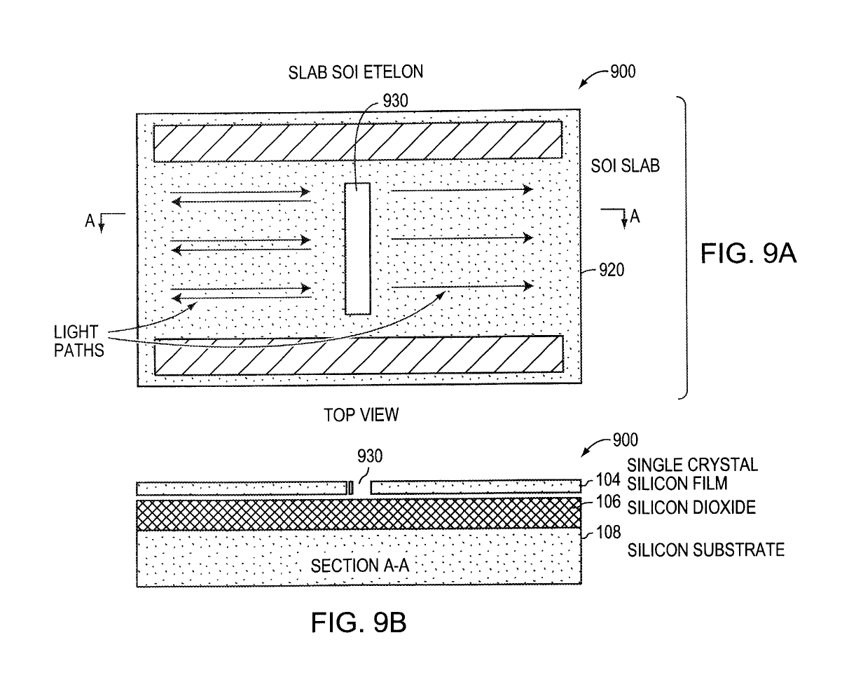

FIGS. 9A and 9B are diagrams, generally 900, that show an illustrative embodiment comprising an etalon 930, in top view and in cross-section, respectively. The etalon 930 is simply a slit etched in the silicon wafer 920 and associated layers providing a resonance, which will pass only one wavelength band making a filter. The slit width can be accurately controlled with state of the art lithography. In this etalon 930 device, as in the other structures described above, the surfaces which are etched in the silicon must be smooth to avoid scattering and to make a narrow band width etalon 930. Smoothing techniques can be used to reduce the roughness, which is expected to be around 2 nm before smoothing. Modifications and variations of this design can be constructed, to tune the etalon to minimize loss.

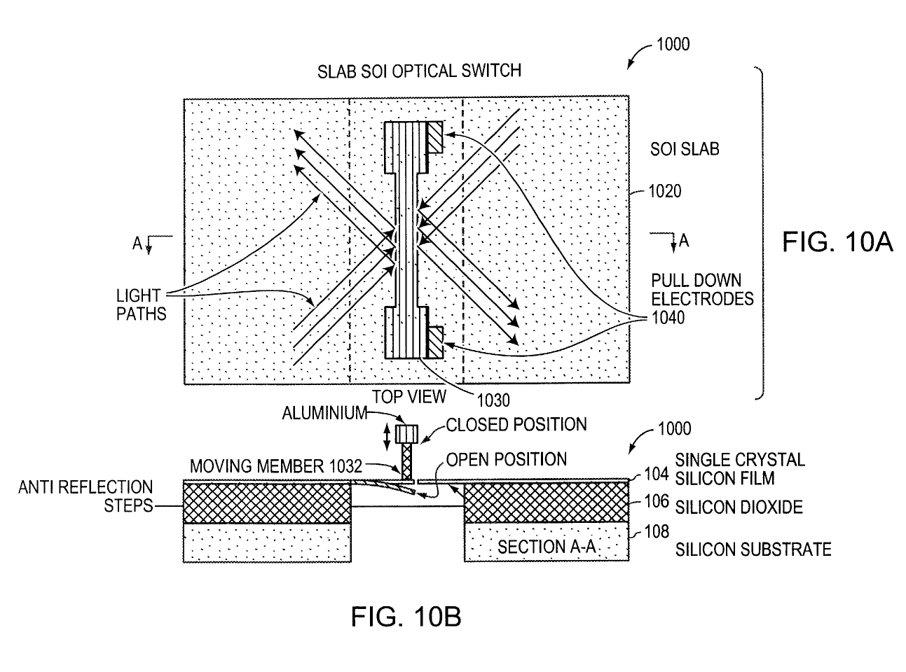

FIGS. 10A and 10B are diagrams, generally 1000, that show an illustrative embodiment of a micro electro mechanical optical switch 1030, in top view and in cross-section, respectively. An aluminum member 1032 is pulled down into contact with a thinned section of slab guide 1020. The light, which is moving 45 degrees relative to the direction of the member 1032, can pass with low loss when the member 1032 is in the up position. When the member 1032 is down, the light reflects with high efficiency at 90 degrees. Such a switch could be used to drop out a light path or it could be used in a cross bar switch. The switch further comprises electrodes 1040 used to electrically operate the switch 1030.

Additional elements, which are important in optical communication components, are attenuators for absorbing the scattered light. A high resistance metal layer on the silicon can help absorb the light in the silicon, and implantation in the silicon dioxide can provide loss in insulating layer.

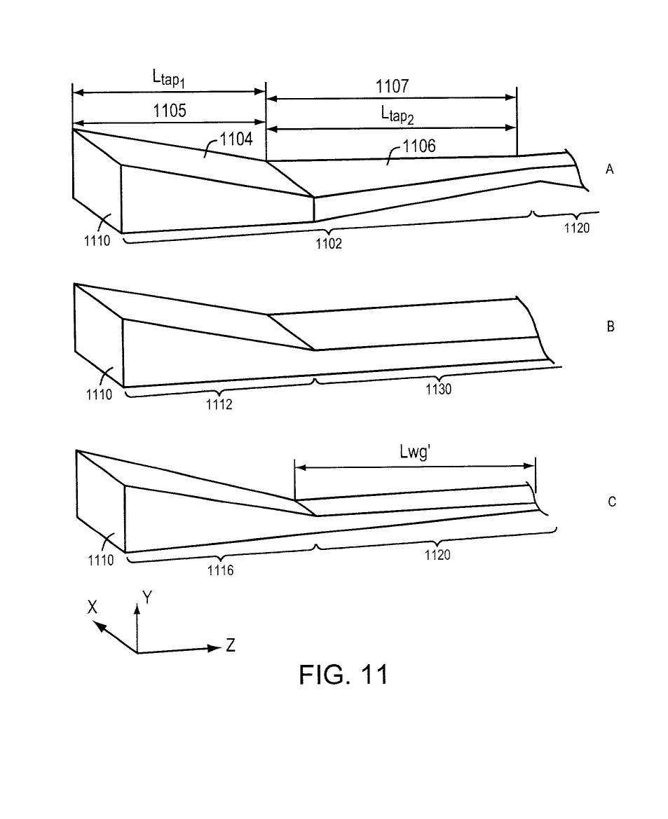

FIG. 11 is a diagram that shows three illustrative taper designs for optical couplers of the invention. At the bottom of FIG. 11 are a set of orthogonal axes, labeled x, y, an z, which indicate how dimensions are measured in the illustrative designs. FIG. 11 A depicts a taper design for use in connecting a single mode optical fiber (not shown) to a single mode waveguide. Single mode optical fibers are well known in the optical communication arts. In the following description, light is described as being delivered by a single mode fiber to the optical coupler of the invention, and therethrough to a waveguide. It will be recognized that the coupler is bi-directional and that the direction of communication of the light can equally well be from the waveguide to the coupler and therethrough to the optical fiber. Bi-directional communications can be performed simultaneously or sequentially. In FIG. 11A radiation from such a fiber impinges on a facet 1110 of a dual stage optical coupler 1102. The facet 1110 is designed to accept optical radiation from a source with minimized losses. In some embodiments, the facet 1110 comprises an optical coating applied to the surface thereof. Coatings adapted to reduce reflective losses, known in the optical arts as anti-reflection coatings, are commonly employed in lenses for cameras and binoculars, in photovoltaic solar cells, in optical filters, and the like. Dual stage optical taper 1102 comprises a first tapered region 1104 which is tapered in a first dimension and of substantially constant width in a second dimension. The first tapered region has a length 1105 denoted by the label Lₜₐₚ₁. Dual stage optical taper 1102 further comprises a second tapered region 1106 which is substantially constant in the first dimension, and is tapered in the second dimension. The second tapered region has a length 1107 denoted by the label Lₜₐₚ₂. The optical taper 1102 has an end that abuts an end of single mode waveguide 1120. The waveguide 1120 is a structure having a substantially constant cross section, the cross section being measured in a plane perpendicular to the direction of propagation of light in the waveguide 1120. In a preferred embodiment, the waveguide 1120 comprises a silicon structure, such as a strip of silicon. In a preferred embodiment, the waveguide 1120 has a cross sectional dimension that is less than 380 nm. In a further preferred embodiment, the waveguide 1120 propagates only one optical mode.

FIG. 11B shows an illustrative taper design in which a single mode fiber (not shown) is in communication with a multimode waveguide by way of an optical coupler of the invention. In FIG. 11B, light from the optical fiber enters facet 110 of optical coupler 1112, which is tapered in only one cross sectional dimension. The length of the tapered region is denoted by Lₜₐₚ. The optical coupler 1112 has an end that abuts an end of multimode waveguide 1130, which is a strip of semiconductor material, such as silicon.

FIG. 11C shows an illustrative taper design in which a single mode fiber (not shown) communicates with a single mode waveguide 1120 by way of optical coupler 1116. In this embodiment, optical coupler 1116 has two cross sectional dimensions that both change in a single tapered region. The length of the tapered region is denoted L. While all of the illustrative tapers are shown as linear tapers, it will be understood that tapers having non-linear cross sectional variations are also contemplated. As already indicated, an important feature of the invention is that the cross sectional dimension is accurate to within 50 nanometer tolerance of the desired value. Another important feature of the invention is that the waveguide comprise a surface having a surface roughness of less than 3 nm rms.

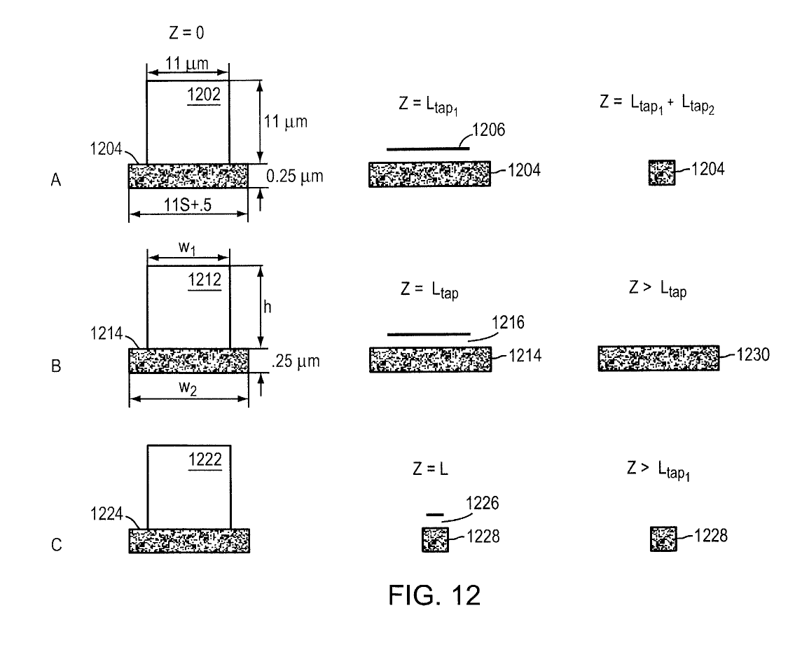

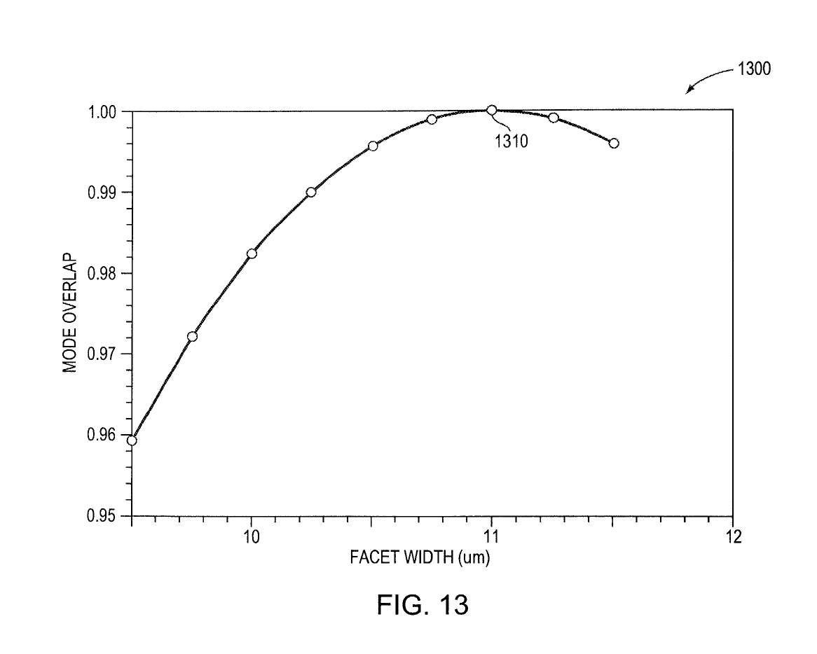

FIG. 12 is a diagram, not to scale, showing the cross sections of three different illustrative optical couplers and their associated waveguides at three positions along the optical propagation direction of each illustrative example. FIG. 12 shows the cross sections at positions along the z axis as presented in FIG. 11. FIG. 12A shows illustrative cross sections of the optical coupler of FIG. 11A. The left-most cross section is that at an end of the optical coupler, designated by the location z=0. In the illustrative cross section, the end is a facet having a cross section 1202 of approximately square shape having dimensions of approximately 11 μm×11 μm that is disposed adjacent a semiconductor waveguide layer 1204 having a width of approximately 11.5±0.5 μm and a height of approximately 250 nm. The dimensions of the faceted end of the optical coupler are selected in this embodiment to match a particular optical fiber that provides an optical beam of specific dimensions. In the event that a different fiber, or a different size of optical beam is intended to be used, the dimensions of the facet can be changed to provide a proper match,. Further discussion of this feature is presented below with regard to FIG. 13. In the center panel, a rectangular cross section at the position z=Lₜₐₚ₁ is depicted. The taper 1106 has been reduced in one dimension (here the y-dimension) to virtually zero thickness, while the second dimension (the x-dimension) is still approximately 11 μm, and the waveguide layer 1204 has not had its dimensions modified. In the panel at the right, corresponding to a distance z=Lₜₐₚ₁+Lₜₐₚ₂, the cross section of the taper 1102 has been reduced to substantially zero in the y-direction, and to substantially the dimension of the waveguide 1120 in the x-direction. The cross section 1204 corresponds substantially to the semiconductor waveguide 1120 itself, having a cross section in one embodiment of substantially 250 nm×250 nm.

FIG. 12B shows illustrative cross sections of the optical coupler 1112 and the associated waveguide 1130 that are depicted in FIG. 1B. The left-most panel of FIG. 12B depicts a cross section is that at an end of the optical coupler 1112, designated by the location z=0. In the illustrative cross section, the end is a facet having a cross section 1212 of approximately square shape having dimensions of approximately 11 μm×11 μm that is disposed adjacent a semiconductor waveguide layer 1214 having a width of approximately 11.5±0.5 μm and a height of approximately 250 nm. The dimensions of the faceted end of the optical coupler are selected in this embodiment to match a particular optical fiber that provides an optical beam of specific dimensions. See FIG. 13. In the center panel, a rectangular cross section at the position z=Lₜₐₚ is depicted. The taper 1112 has been reduced in one dimension (here the y-dimension) to virtually zero thickness as shown in cross section 1216, while the second dimension (the x-dimension) is still approximately 11 μm, and the waveguide layer 1214 has not had its dimensions modified. In the panel at the right, corresponding to a distance z>Lₜₐₚ, the cross section of the taper 1112 has been reduced to substantially zero in the y-direction, but has not been reduced in width. The cross section 1230 that is observed corresponds substantially to the semiconductor waveguide 1130 itself, having a cross section in one embodiment of substantially 250 nm height by a width that is considerably larger, for example, several microns.

FIG. 12C shows illustrative cross sections of the optical coupler 1116 and the associated waveguide 1120 that are depicted in FIG. 11C. The left-most panel of FIG. 12C depicts a cross section is that at an end of the optical couplerl 116, designated by the location z=0. In the illustrative cross section, the end is a facet having a cross section 1222 of square shape having dimensions of approximately 11 μm×11 μm that is disposed adjacent a semiconductor waveguide layer 1224 having a width of approximately 11.5±0.5 μm and a height of approximately 250 nm. The dimensions of the faceted end of the optical coupler are selected in this embodiment to match a particular optical fiber that provides an optical beam of specific dimensions. See FIG. 13. In the center panel, a cross section at the position z=L is depicted. The taper 1116 has been reduced in one dimension (here the y-dimension) to virtually zero thickness as shown in cross section 1226, while the second dimension (the x-dimension) is has been reduced to a dimension similar to that of the waveguide 1120, or approximately 250 nm, and the waveguide layer 1228 has had one of its dimensions modified (corresponding to the x dimension) to approximately 250 nm. In the panel at the right, corresponding to a distance z>Lₜₐₚ, the waveguide 1120 has a cross section of substantially square cross section with an edge dimension of approximately 250 nm.

FIG. 13 is a graph 1300 that shows an illustrative theoretical analysis of the coupling between an optical fiber and an optical coupler of the invention. In the example shown in FIG. 13, an SMF-28 optical fiber supplied by Corning, Inc, Corning, N.Y., that has a 10.4 micron mode field diameter Gaussian beam profile is coupled into square cross section input facets of dimensions ranging from 9.5 micron facet width to 11.5 micron facet width. A maximum coupling of 100% mode overlap 1310 occurs at a facet width of 11.0 microns. Overlaps of 99% or above occur in the range of facet widths of approximately 10.25 microns to more than 11.5 microns. Overlaps in the range of facet widths of approximately 9.5 micron to 11.5 microns are all substantially equal to or greater than approximately 96%. It is contemplated that different facet dimensions will provide optimal matching conditions for optical fibers having different beam dimensions.

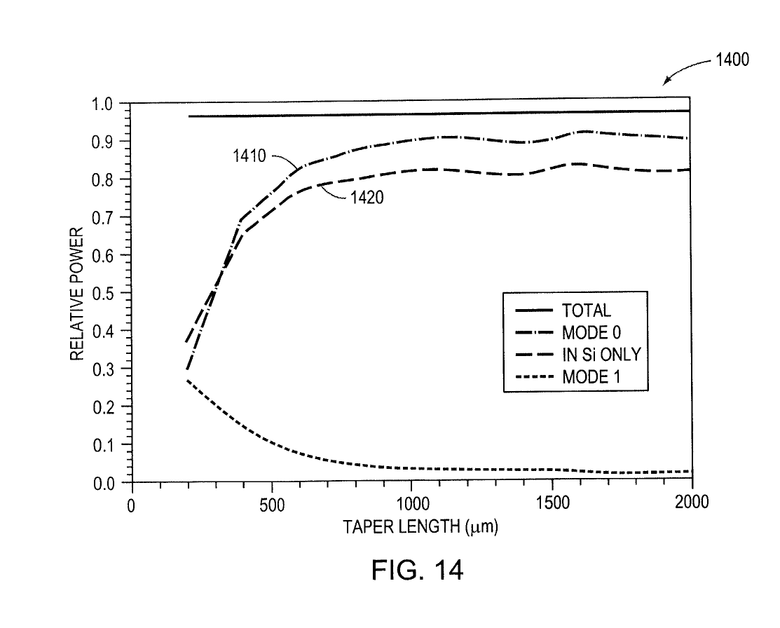

FIG. 14 is a diagram 1400 that shows the variation of power in an optical coupler of the invention as a function of the length of the taper. In determining the behavior shown in FIG. 14, illumination of 1.55 microns wavelength having a 10.4 micron Gaussian beam, in the TE polarization, is coupled into a silicon taper coupler having a 1 micron silicon dioxide overcoat and followed by a silicon waveguide having a square cross section of approximately 250 nm×250 nm and a one micron silicon dioxide layer on each bounding surface of the waveguide. The taper coupler is fabricated with a 50 nm silicon dioxide etch stop layer. Curve 1410 of FIG. 14 indicates that the power in the mode 0 propagation mode represents more than 85% of the propagated power for coupler lengths beyond approximately 1000 microns, and about 75% of the propagated power for coupler lengths over approximately 500 microns. Curve 1420 of FIG. 14 indicates that approximately 70% of the propagated optical power traverses the silicon taper for coupler lengths over 500 microns, and that approximately 80% of the propagated optical power traverses the silicon taper for coupler lengths of 1000 microns or more.

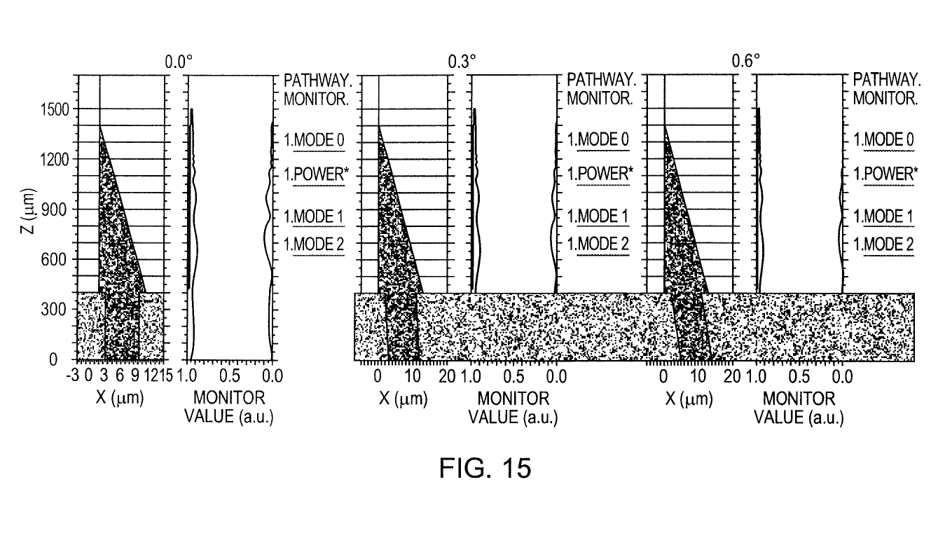

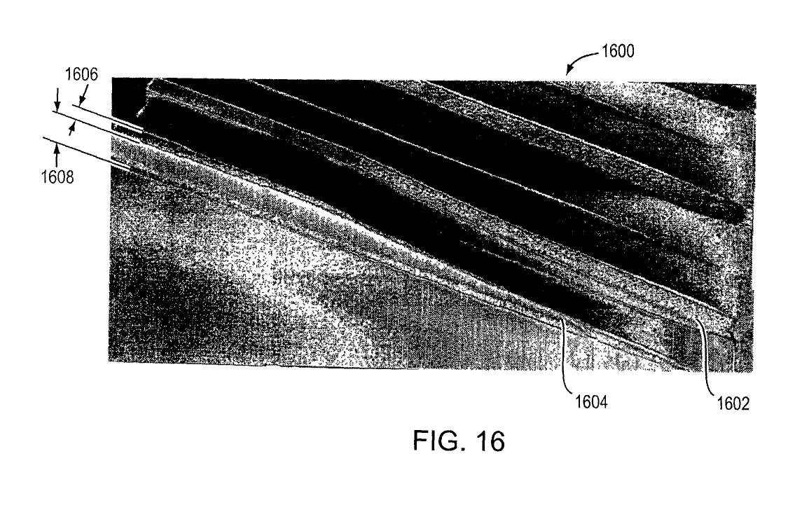

FIG. 15 is a diagram 1500 that depicts the propagation of optical power within a coupler of the invention as a function of angle of impingement of the illumination. FIG. 15 depicts three cases, going from left to right, that show the physical layout of the coupler and the total power applied, and the power in TE modes 0, 1 and 2 within the fiber and the coupler with impingement at 0.0 degrees, 0.3 degrees and 0.6 degrees for a coupler having a taper with an angle of substantially 0.6 degrees. At distances beyond approximately 1200 microns into the coupler, all cases show substantially all of the power propagating in TE mode 0. However, as the angle of impingement approaches 0.0 degrees, there is observed a larger mode mixing effect, with power appearing in both modes 1 and 2. At the impingement angle of 0.6 degrees, the mode mixing effect is minimized.

FIG. 16 is a microimage 1600 of several illustrative optical couplers of the invention. An illustrative silicon optical coupler 1602 has a profile similar to that of coupler 1112 of FIG. 11B. A further illustrative silicon optical coupler 1604 has a profile similar to that shown in FIG. 11C as optical coupler 1116. As a gauge of dimensions in FIG. 16, the width 1606 of the silicon strip at the left-hand end of silicon optical coupler 1604 is nominally 10 microns, and the height 1608 of the strip is nominally 10 microns. The microimage 1600 was made using an electron microscope.

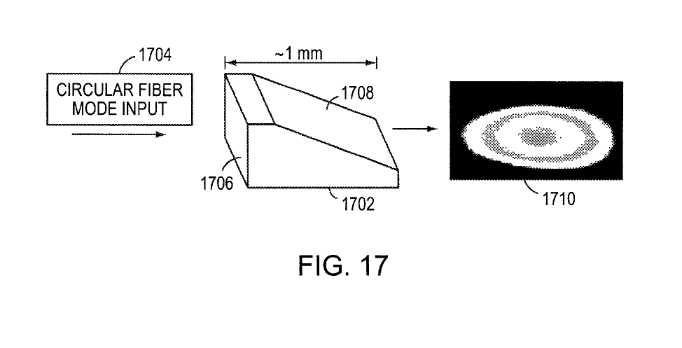

FIG. 17 is a schematic diagram 1700 that shows the mode shape of an optical beam comprising a Gaussian mode after traversing an optical coupler 1702 of the invention. The diagram indicates that a circular fiber mode is provided as input illumination, as denoted by box 1704. The illumination traverses the optical coupler 1702 which is depicted as having an input face 1706 that is approximately square in shape having dimensions of approximately 10 μm×10 μm. The optical coupler has a tapered portion 1708, according to principles of the invention. The tapered portion 1708 is represented schematically as a semiconductor section having a taper in one dimension and a length of approximately one millimeter. The optical coupler 1702 in some embodiments can be a semiconductor section having more than one tapered dimension and a length different from one millimeter. In the exemplary structure of FIG. 17, the taper 1708 terminates at an output facet 1712 having dimensions of approximately 10 μm×3 μm. The output 1710 is an optical beam or signal having a substantially elliptical shape and the majority of its power in a mode 0 described by two orthogonal Gaussian beam profiles. In some embodiments a portion of the output power can appear in a mode other than mode 0.

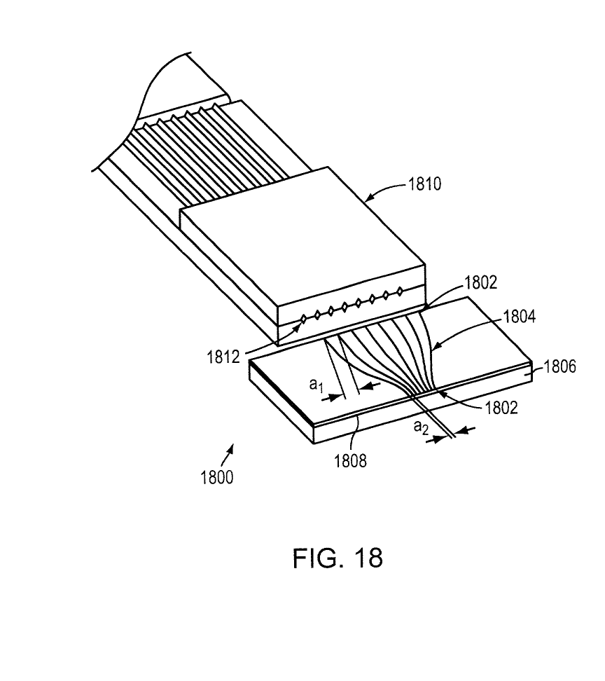

FIG. 18 is a schematic diagram of an illustrative application using the optical coupler of the invention. In this exemplary application, a plurality of communication paths operate in parallel. An optical communication 1800 device that has an optical coupler 1802 disposed at each end of a semiconductor waveguide 1804 is provided for each path. In one embodiment, such as is shown in FIG. 18, a plurality of optical communication devices are fabricated on a single semiconductor substrate 1806, such as a silicon-on-insulator (SOI) wafer. The optical couplers 1802 and the waveguide 1804 of a single communication device can be fabricated so that at least a portion of each is adjacent the same oxide layer 1808, for example the insulator (silicon dioxide) layer of the SOI wafer. The optical communication devices can be fabricated so that a plurality of first optical couplers are disposed relative to each other with first selected positions and orientations. For example, in one embodiment, two or more optical couplers can be spaced apart with a first spacing, denoted a₁ in FIG. 18, and can be aligned parallel to each other in a first plane, so as to accommodate an optical fiber array cable 1810 having a planar array of optical fibers 1812 with a first spacing. At the other end of the optical communication device, in one embodiment, there can be a group of optical couplers disposed in a pattern having a second spacing, denoted a₂, different from the first spacing, and oriented in a different plane, or in a non-planar alignment. Thus, there can be a plurality of second couplers disposed relative to each other with second selected positions and orientations. For the optical communication device to be operative, at least one coupler of the first plurality and at least a corresponding coupler of the second plurality are in communication with a light source and a detector, respectively.

As will be understood by those of skill in the optical communication arts, a communication device of the invention can be operated uni-directionally or bi-directionally, in half-duplex or in full duplex mode. Furthermore, a single optical communication device can be used to simultaneously or serially communicate a plurality of communications using a discrete wavelength for each communication, such as is practiced in DWDM communication.

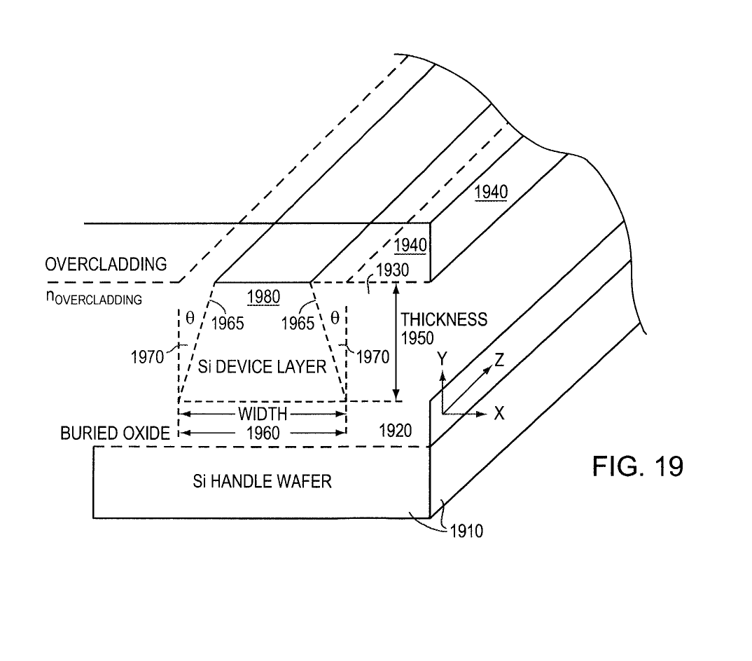

FIG. 19 is a schematic diagram 1900 showing features of the structure of the waveguide of the communication device of the invention. In FIG. 19, a semiconductor layer 1930, such as a silicon layer, is provided as a waveguide layer. A layer of material 1920 having an optical index of refraction less than the waveguide material, such as silicon dioxide in the case of a silicon waveguide, is disposed adjacent the semiconductor layer 1930. A layer of semiconductor material 1910, such as a silicon wafer, is disposed adjacent the layer of insulator material 1920.

The semiconductor layer 1930 has a thickness 1950. In some embodiments, the thickness 1950 is not more than 380 nm. In a preferred embodiment, the thickness 1950 is substantially 240 nm. The semiconductor layer 1930 can be processed, using conventional semiconductor processing methods, or using novel processing methods. In some embodiments, the semiconductor layer 1930 is processed using photolithographic methods and is etched to define a strip 1980 of semiconductor material having substantially the thickness 1950 of the semiconductor layer 1930 and a width 1960 that is defined by a photolithographic mask and process.

In some embodiments, that etching process results in a semiconductor strip 1980 having a thickness 1950 and a width 1960 at the plane of contact of the semiconductor layer 1930 with the layer of material 1920. The etching process in some embodiments causes the semiconductor layer 1930 to be etched with a wall 1965 having an angle θ 1970, where θ≠90 degrees to the plane of the upper surface of the material layer 1920. In such an instance the semiconductor strip 1980 is a strip having a trapezoidal cross section, or a parallelepiped cross section, rather than a rectangular or square cross section, when viewed parallel to the plane of contact of the semiconductor layer 1930 and the material layer 1920. The angle θ can be controlled by controlling such features as the composition of the etchant, the etching temperature, the rate of etching, the crystallographic orientation of the semiconductor layer 1930, and combinations of such features. The waveguide is completed by cladding the waveguide strip 1980 with a material having a lower optical index of refraction than the semiconductor layer 1930. The cladding is provided on the three exposed sides of the semiconductor strip 1980. For embodiments in which the semiconductor strip 1980 is silicon, materials that can be used for the cladding include, but are not limited to silicon dioxide, silicon nitride, silicon oxynitride, sapphire, and air.

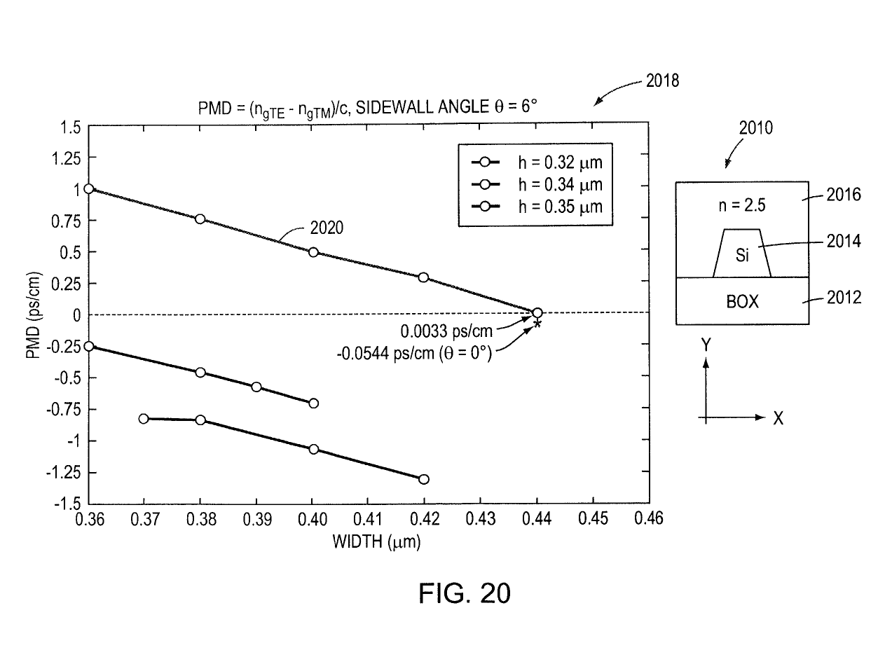

FIG. 20 is a diagram that shows illustrative calculations of polarization mode dispersion in silicon waveguides used with optical couplers of the invention. On the right hand side of FIG. 20 is a cross sectional diagram 2010 of a semiconductor waveguide comprising a buried oxide layer 2012, a silicon waveguide strip 2014 having a trapezoidal cross section, and a cladding material 2016 having optical index of 2.5 that surrounds the three upper surfaces of the silicon waveguide 2014. A material that has an optical index of 2.5 is non-stoichiometric silicon nitride. For the illustrative calculated behavior, the sidewall angle θ is 6 degrees. In FIG. 20, the diagram 2018 shows the calculated dispersive behavior for three thicknesses of the silicon strip 2014, namely 0.32 microns, 0.34 microns, and 0.35 microns, as a function of the width, in microns, of the waveguide strip 2014. The polarization mode dispersion, PMD, is given by the relation

PMD=(n_{gTE}−n_{gTM})/c

It is expected that for a thickness of 0.32 micron 2020, zero dispersion will occur with a silicon strip width of approximately 0.44 microns.

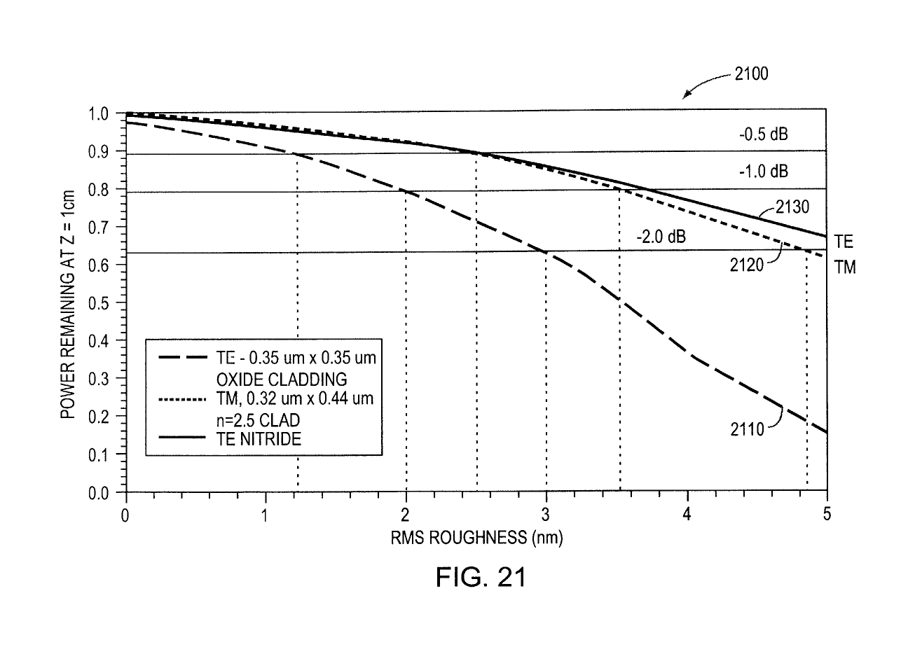

FIG. 21 is a diagram 2100 that shows illustrative calculations of power loss as a function of sidewall roughness. The calculation involves a 1 centimeter waveguide length. The correlation length, Lc , is 200 nm. Several different waveguide structures are considered. A first illustrative example involves the TE mode of a silicon waveguide having a thickness of 0.35 microns by 0.35 microns width, having a cladding layer of silicon dioxide, which is expected to exhibit the calculated behavior indicated by curve 2110. A second illustrative example involves the TM mode of a silicon waveguide having a thickness of 0.32 microns by 0.44 microns width, having a cladding layer of silicon nitride, which is expected to exhibit the calculated behavior indicated by curve 2120. A third illustrative example involves the TE mode of a silicon waveguide having a thickness of 0.32 microns by 0.44 microns width, having a cladding layer of silicon nitride, which is expected to exhibit the calculated behavior indicated by curve 2130. A loss of power is graphed along the vertical axis for a surface roughness expressed in rrns nanometers along the horizontal axis. The greatest degradation for the examples considered occurs for the first example, reaching a loss of 2 dB at a surface roughness of 3 nanometers rms. In a preferred embodiment, the semiconductor strip comprises at least one surface with a surface roughness less than 3 nanometers rms.

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. An optical coupler, comprising:
a silicon structure communicating light between a first cross-sectional area at a first end thereof and a second cross-sectional area at a second end thereof, the light having a propagation direction, the silicon structure having a cross-section defined upon a plane substantially perpendicular to said propagation direction, the cross section having a cross-sectional dimension accurate to within a ±50 nanometer tolerance of a desired value, the silicon structure having adjacent thereto material having a refractive index less than the refractive index of silicon, the adjacent material confining light within the silicon structure.

2. The optical coupler of claim 1, wherein the material adjacent the silicon structure comprises a substrate adjacent to the silicon structure and in a plane substantially parallel to said propagation direction.

3. The optical coupler of claim 2, further comprising a layer of silicon upon which said substrate is disposed.

4. The optical coupler of claim 1, wherein said material adjacent the silicon structure comprises a selected one of silicon dioxide, silicon nitride, non-stoichiometric silicon nitride, silicon oxynitride, sapphire, and air.

5. The optical coupler of claim 1, wherein a thickness of said material adjacent the silicon structure is greater than 500 nm.

6. The optical coupler of claim 1, wherein at least one of the first end and the second end is a facet.

7. The optical coupler of claim 6, wherein the at least one facet comprises an optical coating applied to the surface thereof.

8. The optical coupler of claim 6, wherein the at least one facet is shaped to communicate, with minimal insertion loss, an optical beam to or from an adjacent single mode optical fiber.

9. The optical coupler of claim 6, wherein the at least one facet has an approximately square shape measuring approximately 11 μm×11 μm.

10. The optical coupler of claim 1, wherein a selected change of a dimension of one cross-section compared to the corresponding dimension of an adjacent cross-section is less than 2 percent of the distance between said adjacent cross-sections, the distance being measured along the propagation direction.

11. The optical coupler of claim 2, comprising a selected change of a dimension of one cross-section compared to the corresponding dimension of an adjacent cross-section, said dimension measured in a plane perpendicular to the plane of the substrate.

12. The optical coupler of claim 11 wherein said selected change of a dimension is less than 2 percent of the distance between said adjacent cross-sections, the distance being measured along the propagation direction.

13. An optical coupler array comprising a plurality of optical couplers of claim 1, wherein said plurality of optical couplers are disposed upon a single silicon substrate.

14. An optical communication device comprising
the optical coupler of claim 1, wherein the first-end is a facet; and
a waveguide disposed at least in part upon the same substrate as the optical coupler, an end of the waveguide abutting the second end of the optical coupler and having a substantially similar cross-section as that of the second end of the optical coupler.

15. The optical communication device of claim 14, wherein the waveguide comprises a strip having a substantially constant dimension perpendicular to the propagation direction of light.

16. The optical communication device of claim 15, wherein the waveguide comprises a strip of silicon.

17. The optical communication device of claim 15, wherein the waveguide propagates only one optical mode.

18. The optical communication device of claim 15, wherein at least one cross-sectional dimension of the waveguide is less than 380 nm.

19. The optical communication device of claim 15, wherein the optical waveguide is overcoated with a material having a refractive index less than that of the optical waveguide.

20. The optical communication device of claim 19, wherein said overcoating material is a selected one of silicon dioxide, silicon nitride, non-stoichiometric silicon nitride, silicon oxynitride, and sapphire.

21. The optical communication device of claim 14, wherein the waveguide comprises at least one surface with a surface roughness less than 3 nanometers rms.

22. The optical communication device of claim 14, further comprising a second optical coupler disposed at a second end of the waveguide.

23. The optical communication device of claim 22,wherein a selected one of the first optical coupler and the second optical coupler provides an input to the waveguide and the remaining optical coupler provides an output.

24. An optical communication device array comprising a plurality of optical communication devices of claim 22, wherein said plurality of optical communication devices are disposed upon a single silicon substrate.

25. The optical communication device array of claim 24, wherein a plurality of first optical couplers are disposed relative to each other with first selected positions and orientations, and a plurality of second optical couplers are disposed relative to each other with second selected positions and orientations.

26. An optical communication device array comprising a plurality of optical communication devices of claim 14, wherein said plurality of optical communication devices are disposed upon a single silicon substrate.

27. The optical communication device array of claim 26, wherein a plurality of first optical couplers are disposed relative to each other with first selected positions and orientations, and a plurality of second optical couplers are disposed relative to each other with second selected positions and orientations.

28. An optical apparatus that communicates light, comprising:
an optical communication device array according to claim 27, the optical communication device array having an array of first ends and an array of second ends;
at least one source of light to be communicated, the at least one source in optical communication with a selected first end of a first selected one of the plurality of optical couplers of the optical communication device array;
at least one receiver of light, the at least one receiver in optical communication with the corresponding second end of the first selected one of the plurality of optical couplers of the optical communication device array; and
at least one additional source or receiver of light in optical communication with an end of a second selected one of the plurality of optical couplers of the optical communication device;
whereby a parameter or characteristic of the optical apparatus is improved by the inclusion of the optical coupler along a communication path between the source and the receiver as compared to the parameter or characteristic of the optical apparatus absent the coupler.

29. The optical apparatus of claim 28, wherein the improved parameter or characteristic comprises at least a selected one of an efficacy of transferring optical power among from the at least one transmitter and to the at least one receiver and the at least one additional source or receiver, the mechanical alignment of the at least one transmitter and the at least one receiver and the at least one additional source or receiver, and the crosstalk between at least two of the plurality of optical couplers.

30. An optical apparatus that communicates light, comprising:
an optical coupler according to claim 1, the optical coupler having a first end and a second end;
a source of light to be communicated, the source in optical communication with the first end of the optical coupler; and
a receiver of light, the receiver in optical communication with the second end of the optical coupler;
whereby a parameter or characteristic of the optical apparatus is improved by the inclusion of the optical coupler along a communication path between the source and the receiver as compared to the parameter or characteristic of the optical apparatus absent the coupler.

31. The optical apparatus of claim 30, wherein the improved parameter or characteristic comprises at least a selected one of an efficiency of transmission of optical power from the transmitter to the receiver, a polarization dependence of transmitted optical power, a dispersion of a transmitted light signal, and a shape of a transmitted light beam

32. The optical apparatus of claim 31, wherein a shape of a transmitted light beam is measured at a location selected from one of a point adjacent a facetted end of the silicon structure and situated outside of the silicon structure, a point adjacent a facetted end of the silicon structure and situated within the silicon structure, a point situated inside the silicon structure adjacent a silicon waveguide, a point situated outside the silicon structure adjacent a silicon waveguide, and a point within a silicon waveguide.

33. An optical coupler, comprising:
a silicon structure communicating light between a first cross-sectional area at a first end thereof and a second cross-sectional area at a second end thereof, the light having a propagation direction, the silicon structure having a cross-section defined upon a plane substantially perpendicular to said propagation direction, the cross section having a cross-sectional dimension accurate to within a ±50 nanometer tolerance of a desired value;
an etch stop layer adjacent to the silicon structure and in the plane substantially parallel to said propagation direction, said etch stop layer comprising material that is substantially resistant to substances or processes that etch silicon and that is substantially transparent to the light propagating in the silicon structure;
a first layer of silicon upon which said etch stop is disposed;
a substrate upon which the first layer of silicon is disposed, said substrate comprising a layer of material having a refractive index less than the refractive index of silicon, and substantially confining light propagating in the first layer of silicon; and
a second layer of silicon upon which said substrate is disposed.

34. The optical coupler of claim 33, wherein the etch stop layer comprises a material selected from the group consisting of silicon dioxide, silicon nitride, non-stoichiometric silicon nitride, silicon oxynitride, and sapphire.

35. The optical coupler of claim 33, wherein the thickness of the etch stop layer is less than 300 nm.

36. An optical communication device array comprising a plurality of optical communication devices of claim 33, wherein said plurality of optical communication devices are disposed upon a single silicon substrate.

37. The optical communication device array of claim 36, wherein a plurality of first optical couplers are disposed relative to each other with first selected positions and orientations, and a plurality of second optical couplers are disposed relative to each other with second selected positions and orientations.

38. A method of optical communication, comprising the steps of:
providing an optical coupler, the optical coupler comprising a silicon structure communicating light between a facet at a first end thereof and an optical waveguide at a second end thereof, the light having a propagation direction, the silicon structure having a cross-section defined upon a plane substantially perpendicular to said propagation direction, the cross section having a cross-sectional dimension accurate to within a ±50 nanometer tolerance of a desired value; and
communicating light along a communication path from a source in optical communication with the first end of the optical coupler to a receiver in optical communication with the second end of the optical coupler;
whereby a parameter or characteristic of the communication of light from the source to the receiver is improved by the inclusion of the optical coupler along the communication path between the source and the receiver as compared to the parameter or characteristic of the communication absent the coupler.

39. The method of claim 38, wherein the improved parameter or characteristic comprises at least a selected one of an efficiency of transmission of optical power, a polarization dependence of transmitted optical power, a dispersion of a transmitted light signal, and a shape of a transmitted light beam.

40. The method of claim 39, wherein a shape of a transmitted light beam is measured at a location selected from one of a point adjacent a facetted end of the silicon structure and situated outside of the silicon structure, a point adjacent a facetted end of the silicon structure and situated within the silicon structure, a point situated inside the silicon structure adjacent a silicon waveguide, a point situated outside the silicon structure adjacent a silicon waveguide, and a point within a silicon waveguide.

41. An optical coupler that communicates light between a facet and an optical waveguide, comprising:
a semiconductor structure communicating light between a facet at a first end thereof and an optical waveguide at a second end thereof, the light having a propagation direction, the semiconductor structure having a cross-section defined upon a plane substantially perpendicular to said propagation direction, the cross section having a cross-sectional dimension accurate to within a ±50 nanometer tolerance of a desired value.

42. The optical coupler of claim 41, wherein a first cross-section has the shape of the facet and a second cross-section has the shape of the optical waveguide.

43. The optical coupler of claim 41, wherein a change of a dimension of one cross-section compared to a corresponding dimension of an adjacent cross-section is less than N 2% compared to a distance between said adjacent cross-sections, the distance being measured along the propagation direction.

44. An optical communication device comprising the optical coupler of claim 41, and further comprising a substrate adjacent said optical coupler.
